(19) United States
(12) Patent Application Publication
(10) Pub. No.: US 2015/0032387 A1
(43) Pub. Date: Jan. 29, 2015

(54) NOVEL SYSTEMS AND METHODS THAT FACILITATE UNDERSIDE INSPECTION OF CRAFTS

(71) Applicant: AEROBOTICS, INC., Wilmington, DE (US)

(72) Inventors: Douglas A. Froom, Orangevale, CA (US); William T. Manak, Fair Oaks, CA (US)

(73) Assignee: AEROBOTICS, INC., Wilmington, DE (US)

(21) Appl. No.: 14/370,780

(22) PCT Filed: Jan. 6, 2013
(86) PCT No.: PCT/US2013/020439

§ 371 Date: Jul. 6, 2014

Related U.S. Application Data
(60) Provisional application No. 61/584,216, filed on Jan. 6, 2012.

(51) Int. Cl. G01N 35/00; G05D 1/02; G01M 17/00; G01D 11/02; G01D 11/30

(52) U.S. Cl. CPC G01N 35/0099; G01D 11/02; G01D 11/30; G01N 35/00584; G01M 17/00; G05D 1/0289
USPC 702/33; 73/866.5; 700/255

(57) ABSTRACT

A craft inspection process is described. The craft inspection process includes: (i) locating, using an overhead robot, a candidate craft in space within one or more robotic envelopes and identifying craft offset; (ii) locating, using the overhead robot and the craft offset, a component and/or sub-component of the candidate craft within one of one or more of the robotic envelopes and identifying a component offset and/or the sub-component offset; and (iii) inspecting the component and/or the sub-component using an underside robot and the component offset and/or the sub-component offset.

### RELATED APPLICATIONS

The present application claims priority from U.S. Provisional Application Ser. No. 61/584,216, which was filed on Jan. 6, 2012, which is incorporated herein by reference for all purposes.

### FIELD OF THE INVENTION

The present invention relates to novel systems and methods that facilitate underside inspection of crafts. More particularly, the present invention relates to novel non-destructive inspection systems and methods that facilitate underside inspection of crafts.

### BACKGROUND

Frequent tragedies in airplane transportation have caused concern over the ability of airlines to evaluate the airworthiness of airplanes within their respective fleets. As airframes age, characteristics of materials that make up airframe components change due to stresses and strains associated with flights and landings. Moreover, there is a risk that a state of the airframe material subject to such extreme conditions goes beyond the point of elasticity (i.e., the point the material returns to its original condition) and extends into the point of plasticizing, or worse, beyond plasticizing to failure. As a result, periodic inspections and testing are conducted on airplane components during each airplane component's life cycle. Such inspections and testing are mandated by governing bodies and are largely based on empirical evidence.

Inspections and testing of airplanes are bifurcated into two areas: (1) destructive testing, and (2) non-destructive inspection (NDI), non-destructive testing (NDT) or non-destructive evaluation (NDE). “NDI,” as this term is used hereinafter in the specification, encompasses the meanings conveyed by NDT and NDE, as those are described above. The area of destructive testing, as the name implies, requires the airplane component under scrutiny to be destroyed in order to determine the quality of that airplane component. This can result in a costly endeavor because an airplane component that may have passed the procedure is destroyed, and is no longer available for use. Frequently, where destructive testing is done on samples (e.g. coupons) and not on actual components, the destructive testing may or may not be reflective of the forces that the actual component could or would withstand within the operational envelope of the airplane.

On the other hand, NDI has the advantage of being directly applied to production craft components and/or sub-components in their actual environment. Several important methods of NDI that are performed in a laboratory setting are listed and summarized below.

Radiography involves inspection of a material by subjecting it to penetrating irradiation. Although effective damage detection has been done using neutron radiation, X-rays are the most familiar type of radiation used in this technique. Most materials used in airplane component manufacturing, for example, are readily acceptable to X-rays. In some instances, an opaque penetrant is needed to detect defects.

Realtime X-rays, which are frequently used as part of recent inspection techniques, permit viewing the area of scrutiny while doing a repair procedure. Some improvement in resolution has been achieved by using a stereovision technique where the X-rays are emitted from dual devices, which are offset by about 15 degrees. When viewed together, these dual images give a three-dimensional view of the material. Still, the accuracy of X-rays is generally no better than plus or minus 10% void content. Neutrons (N-ray), however, can detect void content in the plus or minus 1% range. The difficulty in implementing radiography raises safety concerns because a radiation source is being used. Nevertheless, in addition to detecting internal flaws in metals and composite structures using conventional non-radiography related methods, X-rays and neutrons are useful in detecting misalignment of honeycomb cores after curing, blown cores due to moisture intrusion, and corrosion.

Ultrasonic is the most common NDI method for detecting flaws in composite materials. The method is performed by scanning the material with ultrasonic energy while monitoring the reflected energy for attenuation (diminishment) of the signal. The detection of the flaws is somewhat frequency-dependent and the frequency range and scanning method most often employed is called “C-scan.” In this method, water is used as a coupling agent between the sending device and the sample. Therefore, the sample is either immersed in water or water is sprayed between the signal transmitter and the sample. This method is effective in detecting defects even in samples that are substantially thick, and may be used to provide a thickness profile. C-scan accuracies may be in the plus or minus 1% range for void content. A slightly modified method call L-scan can detect stiffness of the sample by using the wave speed, but requires that the sample density be known.

Acousto-ultrasonic, another NDI method, is similar to ultrasound except that separate sensors are used to send the signal, and other sensors are used to receive the signal. Both sensors are, however, located on the same side of the sample, so a reflected signal is detected. This method is more quantitative and portable than standard ultrasound.

Acoustic emission, yet another NDI method, involves detecting sounds emitted by a sample that is subjected to stress. The stress can be mechanical, but need not be. In actual practice, in fact, thermal stresses are the most commonly employed. Quantitative interpretation is not yet possible except for well-documented and simple shapes (such as cylindrical pressure vessels).

Thermography (sometimes referred to as “IR thermography”) is yet another NDI method that detects differences in relative temperatures on the surface undergoing inspection. Differences in relative temperatures on the inspected surface are produced due to the presence of internal flaws. As a result, thermography is capable of identifying the location of those flaws. If the internal flaws are small or far removed from the surface, however, they may not be detected.

In thermography, there are generally two modes of operation, i.e., an active and a passive mode of operation. In the active mode of operation, a sample is subjected to stress (usually mechanical and often vibrational), and the emitted heat is detected. In the passive mode of operation, the sample is externally heated, and the resulting thermal gradients are detected.

Optical holography, yet another NDI method, uses laser photography to give three-dimensional pictures, which are called “holograms.” This method detects flaws in samples by employing a double-image method, according to which two pictures are taken while stress is induced on a sample between the times when a picture is taken. This method has had limited acceptance because of the need to isolate the camera and the sample from vibrations. However, it is believed that phase locking may eliminate this problem. The stresses that are imposed on the sample are usually thermal. If a microwave source of stress is used, moisture content of the sample can be detected. For composite material, this method is especially useful for detecting debonds in thick honeycomb and foam sandwich constructions.

A related method is called shearography. In this method, a laser is used with the same double exposure technique as in holography, where stress is applied between exposures. However, in this case, an image-shearing camera is used in which signals from the two images are superimposed to provide an interference pattern and thereby reveal the strains in the samples. According to this method, strains are detected in a particular area, and the size of the pattern can give an indication of the stresses concentrated in that area. As a result, shearography allows a quantitative appraisal of the severity of the defect. The attribute of quantitative appraisal, relatively greater mobility of shearography over holography, and the ability to stress the sample using mechanical, thermal, and other techniques, has given this method wide acceptance since its introduction.

### SUMMARY

In one aspect, the present teachings provide a craft inspection process. The craft inspection process includes: (i) locating, using an overhead robot, a candidate craft in space within one or more robotic envelopes and identifying craft offset; (ii) locating, using the overhead robot and the craft offset, a component and/or sub-component of the candidate craft within one of one or more of the robotic envelopes and identifying a component offset and/or sub-component offset; (iii) conveying from the overhead robot to one or more computer systems at least one information chosen from a group including a point of origin of the component and/or the subcomponent, one or more boundary coordinates of the component and/or the subcomponent, an overhead scan path, signal to commence underside inspection, component offset and subcomponent offset; and (iv) processing, using one or more of the computer systems, at least one information received from the overhead robot to develop underside information used during underside inspection. In a preferred embodiment of the present teachings, the craft inspection process further includes conveying the underside information from one or more of the computer systems to an underside robot.

In another aspect, the present teachings provide a process for developing a reference database. The process includes for developing a reference database includes: (i) teaching, using an overhead robot, location of a reference craft in space within one or more robotic envelopes; (ii) teaching, using the overhead robot, location of a component and/or a sub-component of the craft within one of one or more of the robotic envelopes; (iii) identifying an overhead point of origin for the component and/or the sub-component; and (iv) using the overhead point of origin for the component and/or the subcomponent and arriving at an underside point of origin for an underside robot.

According to one embodiment of the present teachings, the reference craft is a craft chosen from a group comprising an aircraft, a boat, a submarine, a bicycle, a car, a truck, a bus, a motorcycle, a train, a ship, a watercraft, a sailcraft, a hovercraft and a spacecraft. The teaching of location of the referenced craft in space may include: (i) aligning a nose gear or a main landing gear tire to a center line and a line on a floor of one of one or more of the robotic envelopes, respectively; (ii) immobilizing the reference craft; (iii) taking load off tires or actuators or loading tires and actuators of the reference craft; and (iv) teaching the overhead robot, using machine vision, at least one reference coordinate defining a boundary of the reference craft. In preferred embodiments of the present teachings, the above-mentioned at least two edges defining the boundary of the reference craft include any two features chosen from a group comprising an edge of a wing, an edge of a vertical stabilizer, a location on the nose, and a location and/or edge of a fuselage.

Teaching location of the component and/or the subcomponent may include teaching the overhead robot, using machine vision, one or more reference coordinates defining a boundary of the component and/or the subcomponent. The above-mentioned act of using includes conveying the point of origin of the component and/or subcomponent from the overhead robot to the underside robot through one or more computer systems. This may be accomplished in a number of different ways. By way of example, conveying the point of origin may include: (i) conveying the point of origin from the overhead robot to an overhead robot system computer; (ii) conveying the point of origin from the overhead robot system computer to one or more computer systems; (iii) conveying the point of origin from one or more of the computer systems to an underside robot system computer; and (iv) conveying the point of origin from the underside robot system computer to the underside robot.

In yet another aspect, the present teachings provide another process for developing a reference database. This process includes: (i) teaching, using an overhead robot, location of a reference craft in space within one or more robotic envelopes; (ii) teaching, using the overhead robot, location of a component and/or a sub-component of the craft within one of one or more of the robotic envelopes; (iii) identifying an overhead point of origin for the component and/or the sub-component and one or more boundary coordinates for the component and/or the sub-component; (iv) using the overhead point of origin and one or more of the boundary coordinates of the component and/or the sub-components, generating an overhead scan path for the component and/or the sub-component; (v) arriving at an underside point of origin for an underside robot using the overhead point of origin; and (vi) developing an underside scan path for the underside robot from the underside point of origin and the overhead scan path of the component and/or the sub-component or from the underside point of origin and the boundary coordinates of the component and/or the subcomponent.

In yet another aspect, the present teachings provide another craft inspection process. This process includes: (i) locating, using an overhead robot, a candidate craft in space within one or more robotic envelopes and identifying a craft offset; (ii) locating, using the overhead robot and the craft offset, a component and/or subcomponent of the candidate craft within one or more robotic envelopes and identifying a component offset and/or a subcomponent offset; (iii) obtaining, using the overhead robot, one or more boundary coordinates of the component and/or the sub-component, and the boundary coordinates providing overhead location information for the component and/or the subcomponent; (iv) arriving at one or more facility unit coordinates using the boundary coordinates and the component offset and/or the subcomponent offset, and the facility unit coordinates being used by an underside robot during an underside inspection of the component and/or the sub-component, and the facility unit coordinates account for a distance between the robotic envelope and a home position of the underside robot; and (v) implementing the facility unit coordinates for underside inspection of the component and/or the sub-component using the underside robot.

The above-mentioned boundary coordinates may be stored in any at least one of one or more computer systems, an overhead robot system computer and an underside robot system computer. In one embodiment of the present teachings, the craft inspection process further includes arriving at a facility unit offset, which is a difference between a reference plane and a candidate plane. In this embodiment, the reference plane is defined by a point of origin of a production facility unit and a home position of an overhead robot inside the production facility unit. Furthermore, the candidate plane is defined by a point of origin of a reference facility unit and a home position of the overhead robot inside the reference facility unit. Further still, in this embodiment, the candidate craft undergoes inspection inside the production facility unit and the reference craft is taught inspection parameters inside the reference facility unit. The above-mentioned act of locating the candidate craft in space preferably includes using the facility offset.

In yet another aspect, the present teachings provide another process for developing a reference database. This process includes: (i) teaching, using an overhead robot, location of a reference craft in space within one or more robotic envelopes; (ii) teaching, using the overhead robot, location of a component and/or sub-component of the reference craft within one of one or more of the robotic envelopes; and (iii) developing a scan path to be implemented by an underside robot during inspection of the component and/or the sub-component.

In one preferred embodiment of the present teachings, the act of developing a scan path includes teaching the underside robot a travel path between a reference point of location to a component point of location and/or a subcomponent point of location. In this embodiment, the reference point of location is located on the reference craft and the component point of location and/or the subcomponent point of location is located on the component and/or the subcomponent. The process of developing a reference database of may further include a act of developing a scan path for an overhead robot that operates in a corresponding manner to the underside robot during inspection of the component and/or the component.

In yet another aspect, the present teachings provide another a yet another craft inspection process. This process includes: (i) locating, using an overhead robot, a candidate craft in space within one or more robotic envelopes and identifying craft offset; (ii) locating, using the overhead robot and the craft offset, a component and/or sub-component of the candidate craft within one of one or more of the robotic envelopes and identifying a component offset and/or sub-component offset; and (iii) inspecting the component and/or the sub-component using the underside robot and the component offset and/or the subcomponent offset. In preferred implementation of this aspect, the craft inspection process further includes: (i) conveying from the overhead robot to one or more computer systems at least one information chosen from a group including a point of origin of the component and/or the subcomponent, one or more boundary coordinates of the component and/or the subcomponent, an overhead scan path, signal to commence underside inspection, component offset and subcomponent offset; and (ii) processing, using one or more of the computer systems, the at least one information received from the overhead robot to develop underside information used during underside inspection.

The above-mentioned act of inspecting may include: (i) instructing the underside robot to travel a travel path between a reference point of location to a component point of location and/or a subcomponent point of location; and (ii) instructing the underside robot to implement a predetermined scan path. As mentioned above, the reference point of location is located on the reference craft and the component point of location and/or the subcomponent point of location being located on the component and/or the subcomponent. The predetermined scan path may be based on a scan path associated with the overhead robot and/or boundary coordinates obtained from the overhead robots.

In yet another aspect, the present teachings provide a craft inspection facility unit. This craft inspection facility unit includes: (i) a robot associated with a non-destructive inspection (“NDI”) system and capable of inspecting an underside of a craft; (ii) one or more rails extending along a dimension and disposed on a floor surface of the inspection facility unit; (iii) a rail drive subsystem proximate to one or more of the rails and capable of mobilizing the robot on one or more of the rails; and (iv) wherein during an operational state of the robot, the rail drive subsystem mobilizes the robot to a predetermined location on the rail. In one embodiment of the present craft facility units, the NDI system is at least one inspection system chosen from a group comprising x-ray, ultrasonics, thermography, holography, shearography and neutron radiography. The above-mentioned rail drive subsystem may include one member chosen from a group comprising a motor, a rack and pinion drive mechanism, an encoder and a resolver. During operation, the rail drive subsystem is capable of mobilizing the robot according to a predetermined scan path associated with the NDI system and with a component or a subcomponent of the craft.

In yet another aspect, the present teachings provide another craft inspection facility unit. This craft inspection facility includes: (i) a robot associated with a non-destructive inspection (“NDI”) system and capable of inspecting an underside of a craft; (ii) one or more rails extending along a dimension of the inspection facility unit; and (iii) wherein each of one or more of the rails capable of supporting thereon the robot, and during an operational state of the robot, the robot functions as an image receiver for an overhead robot functioning as an energy source that is disposed above the craft or the robot functions as the energy source for the overhead robot functioning as the image receiver that is disposed above the craft. Inside this facility, the NDI system may be a real-time x-ray system and during an operational state of the robot, the robot receives signals generated from the imaging source.

In the event underside inspection is desired, one or more of the rails are preferably disposed on a floor surface of the inspection facility unit. In certain embodiments of the present teachings, the robot has an underside scan path implemented during inspection of a component and/or a subcomponent of the craft and the overhead robot has an overhead scan path implemented during inspection of the component and/or the subcomponent. Furthermore, the underside scan path corresponds to the overhead scan path such that an image of at least a portion of the component and/or the subcomponent is obtained during inspection.

In yet another aspect, the present teachings provide an underside craft inspection system. This underside craft inspection system includes: (i) one or more rails capable of supporting a robot associated with a non-destructive inspection (“NDI”) system; (ii) one or more beds proximate to one or more rails of the and capable of supporting the robot; (iii) one or more bed drive subsystems proximate to one or more of the beds and capable of mobilizing the robot on one or more of the beds to a predetermined location on one or more of the beds; and (iv) wherein during an operational state of the robot, one or more of the bed drive subsystems mobilizes the robot to a predetermined location on one or more of the beds and allowing selection of one or more rails for inspection of a component and/or subcomponent of the craft.

In one preferred embodiment of the present underside craft inspection systems, one or more of the bed drive subsystems is one member chosen from a group comprising a motor-driven ball screw, a rack and pinion drive system and a motor-driven cable system. Bed drive subsystems with different designs may be used. Bu way of example, one or more of the bed drive subsystems includes at least one component chosen from a group comprising a motor, an encoder, and a resolver. As another example, one or more of the bed drive subsystems extends along a dimension of robotic envelope, inside which the craft undergoes inspection. As yet another example, one or more of the bed drive subsystems is capable of having mobilized thereon multiple index positioners one at a time or simultaneously.

The underside craft inspection system preferably further includes a controller for mobilizing at least one of the index positioners on one or more of the beds. This underside inspection system may further include an index positioner capable of supporting thereon one or more underside robots, at least some of which are associated with an NDI system, and one or more of the bed rails mobilize the index positioner along one or more of the beds and facilitate selection of one or more of the rails. Preferably, one or more of the beds include a bearing surface upon which the index positioner is positioned during mobilization of the index positioner. The bearing surface may facilitate continuous mobilization of the index positioner inside one of one or more of the beds. In one preferred implementation of the present teachings, the bearing surface includes linear roller bearings that are secured to a bottom or a side of each of one or more of the beds. When properly installed and utilized, the bearing surface is designed to prevent side-to-side movements of the index positioner. Side-to-side movements include movements in a direction that is perpendicular to a mobilization direction of the index positioner.

When multiple index positioners are used, it is preferably to have multiple bed drive subsystems. In this embodiment of the present arrangements, each of one or more of the beds have space defined therein to house the multiple bed drive subsystems for mobilizing the multiple index positioners.

In one preferred embodiment of the present teachings, one or more index positioner rails are disposed on the index positioner and are capable of supporting thereon the robot such that when one or more rails are selected for inspection of the component and/or the subcomponent, one or more of the index positioner rails align to one or more of selected rails. In this configuration, it preferably to have one or more of the index positioner drive subassemblies proximate one or more of the index positioner rails and designed to mobilize a cart on the index positioner rails.

The index positioner drive subassembly preferably includes a rack and pinion mechanism proximate to at least one of one or more of the rails and the cart. In this configuration, the rack and pinion facilitates mobilization of the cart from the index positioner rails to the rails. One or more beds may be any one of raised, recessed and even (i.e., at the same level) relative to a floor surface of an inspection facility unit.

One embodiment of the present systems includes two or more beds separated by a distance, and this embodiment further includes a plurality of bed connectors (which are similar to the rails disposed on the floor surface of a facility unit) that extend between two or more of the beds and allow movement of a cart from a location on one bed to another location on another bed.

The underside craft inspection may also include a cart disposed on the index positioner. The cart is designed to be mobile on the rails. It may be capable of supporting thereon one or more of the robots.

The underside craft inspection further includes a rail drive sub-system proximate to one or more of the rails. The rail drive subsystem is preferably designed to facilitate mobilizing the cart on the rails and includes one member chosen from a group comprising a rack and pinion drive system, a motor-driven cable and chain system.

The cart may include one or more cart rails disposed thereon. Cart rails are capable of supporting thereon the robot, which may carry out underside inspection of the craft. In preferred embodiment of the present carts, a lower carriage is provided. The lower carriage is preferably capable of movement in a direction that is perpendicular or parallel to a movement direction of one or more of the rails. The underside craft inspection systems may further include one or more cart drive subsystems proximate to one or more of the cart rails. The cart rails are preferably designed to mobilize the lower carriage on the cart rails. One or more of the cart drive subsystems may include at least one member selected from a group consisting of a rack and pinion drive system, a motor-driven cable and chain system.

The robot mounted or secured on the cart or lower carriage may be of any type. However, in a preferred arrangement of the underside craft inspection systems, a pedestal robot or a platform robot mounted on the lower carriage is used for inspecting locations on the craft that cannot be reached from the lower carriage in the absence of the pedestal robot or the platform robot.

In a yet another aspect, the present teachings provide a craft inspection facility unit. This craft inspection facility unit: (i) one or more beds; (ii) an index positioner capable of supporting thereon one or more underside robots, each of which is associated with the NDI system and is capable of inspecting an underside of a craft; and (iii) wherein one or more of the beds facilitate mobilization of the index positioner to facilitate underside inspection of the craft using one or more of the underside robots.

The above-mentioned craft inspection facility unit preferably further includes one or more rails disposed perpendicular to one or more of the beds such that one or more beds are designed to align the index positioner to one or more predetermined rails. In one embodiment, the present craft inspection facility units further include one or more overhead robots associated with a non-destructive inspection (“NDI”) system and capable of inspecting at least an overhead portion of a craft. In this configuration, the underside inspection of the craft using one or more of the underside robots is carried out in a corresponding manner to overhead inspection of the craft using one or more of the overhead robots.

In one preferred design, the present craft inspection facilities further include a cart secured on the index positioner. In this design, the cart is capable of holding one or more robots, each of which is associated with a single NDI system. The cart may be capable of being displaced by a drive sub-system that includes at least one member chosen from a group comprising of a rack and pinion drive system, a motor-driven cable system and a chain system.

The present craft inspection facilities may include a lower carriage secured on a cart and capable of movement in a direction that is perpendicular or parallel to one or more of the beds. As mentioned before, a pedestal robot or a platform robot may be mounted on the lower carriage for inspecting locations on the craft that cannot be reached by the lower carriage in the absence of the pedestal robot or the platform robot.

In yet another aspect, the present teachings provide an inspection control system. This system includes: (i) one or more overhead robots designed to inspect an upper portion of a craft; (ii) one or more overhead control subsystems, at least some of which are designed to control one of one or more of the overhead robots; (iii) one or more underside robots designed to inspect an underside portion of the craft; (iv) one or more underside control subsystems, at least some of which are designed to control one of one or more of the underside robots; (v) one or more computers capable of being communicatively coupled to one or more of the overhead control subsystems and one or more of the underside control subsystems; and (vi) wherein during operation of the inspection control system, information from one control subsystem is conveyed to another control subsystem using one or more of the computer systems.

The inspection control system preferably further includes: (i) an overhead robot workstation; (ii) an underside robot workstation; and (iii) wherein the overhead robot workstation and the underside robot workstation are designed to interact with one or more of the computer systems, such that during operation of the inspection control system, information from one control subsystem is conveyed to another control subsystem through the overhead robot workstation and the underside robot workstation.

One or more of the overhead control subsystems may further include: (i) a controller for transferring location information of one of one or more of the overhead robots during inspection; and (ii) an integrating controller for integrating location information of two of one or more of the overhead robots or for integrating scan paths, manual control points of one of one or more of the overhead robots and new points taught to one of one or more of the overhead robots during development of a reference database. In one embodiment of the present teachings, the inspection control system further includes: (i) a collision detection avoidance subsystem for one of one or more of the overhead robots for avoiding collision between one of one or more of the overhead robots and another of one or more of the overhead robots or with a component and/or a subcomponent of the craft; and (ii) a collision detection avoidance subsystem for one of one or more of the underside robots for avoiding collision between one of one or more of the underside robots and another of one or more of the underside robots or with a component and/or a subcomponent of a craft undergoing inspection. One or more of the overhead control subsystems may provide to one or more of the computer systems any one information chosen from a group comprising a point of origin of the component and/or the subcomponent, one or more boundary coordinates of the component and/or the subcomponent, an overhead scan path, signal to commence underside inspection, component offset and subcomponent offset.

In yet another aspect, the present teachings provide a craft inspection system. This system includes: (i) one or more overhead robots designed to inspect an upper portion of a craft; (ii) one or more underside robots designed to inspect an underside portion of the craft; (iii) one or more computer systems capable of being communicatively coupled to one or more of the overhead robots and to one or more of the underside robots; and (iv) wherein during operation of the inspection control system, one or more of the computer systems facilitate overhead robot and underside robot to inspect the craft in a corresponding manner. One or more of the computer systems preferably use Boolean logic rules to facilitate overhead robot and underside robot to inspect the craft in a corresponding manner.

### BRIEF DESCRIPTION OF THE DRAWINGS

FIG. 1 shows a perspective view inside a craft inspection facility, in accordance with one present arrangement, that includes some components of a craft inspection system.

FIG. 2 shows a side view of a yoke, in accordance with one present arrangement, associated with a realtime X-ray system shown in FIG. 1.

FIG. 3 shows a perspective view inside another craft inspection facility, in accordance with a preferred present arrangements, that includes some components to facilitate underside inspection (e.g., an underside robot supported on rails on a floor surface of the facility) of a craft.

FIG. 4 shows a side view of a drive subsystem, in accordance with one present arrangement, used by overhead robots shown in FIGS. 1 and 3.

FIG. 5A shows a side view of a bed drive subsystem, in accordance with one present arrangement, used by an underside robot shown in FIG. 3.

FIG. 5B shows a perspective view of an index positioner, according to one embodiment of the present teaching, and an exemplar index positioner drive subsystem.

FIG. 5C shows a block diagram of the index positioner drive subsystem of FIG. 5B.

FIG. 5D shows a perspective view of a rail disposed between two racks that facilitate movement of a cart during craft inspection.

FIG. 5E shows a perspective view of a subassembly including a cart engaging with rails and racks, according to one embodiment of the present teachings, as shown in FIG. 5D.

FIG. 5F shows an end view of the subassembly shown in FIG. 5E.

FIG. 6 shows a block diagram of an inspection control system, according to one present arrangement.

FIG. 7A shows a perspective view of two craft inspection facilities according to one present design, with varying dimensions and designed for conducting craft inspections.

FIG. 7B shows a top view of a craft inspection facility, according to one present arrangement, capable of conducting underside inspection of crafts.

FIG. 8 shows a top view of a wing component of an exemplar craft that is inspected in a robotic envelope inside the craft inspection facility of FIG. 7B.

FIG. 9 shows a top view of an indexing bed, index positioner and rails inside craft inspection facility of FIG. 7B.

FIG. 10 shows a side view of the index positioner positioned inside the indexing bed of FIG. 9.

FIG. 11 shows a perspective view of the index positioner capable of movement using the drive subsystem of FIG. 5A.

FIG. 12 shows a perspective view of a cart, in accordance with one preferred arrangement, that is secured on the index positioner and is capable of traveling on the rails shown in FIGS. 7, 8 and 9.

FIG. 13 shows a process flow diagram for an exemplar process of developing reference database, according to one aspect of the present teachings, for a craft that may undergo inspection.

FIG. 14 shows a process flow diagram of another exemplar process for developing a reference database, according to another aspect of the present teachings, for a craft that may undergo inspection.

FIG. 15 shows a process flow diagram of an exemplar craft inspection process, according to one aspect of the present teachings.

FIG. 16 shows a location of point of origin, according to one aspect of the present teachings, of a right leading edge box of right horizontal stabilator.

FIG. 17 shows a location of point of origin and boundary coordinates, according to one aspect of the present teachings, of the right leading edge box of right horizontal stabilator shown in FIG. 16.

FIG. 18 shows an exemplar scan path of the right leading edge box of right horizontal stabilator shown in FIG. 16 for a realtime X-ray inspection system.

FIG. 19 shows a process flow diagram of a yet another exemplar process for developing a reference database, according to yet another aspect of the present teachings, for a craft that may undergo an inspection.

FIG. 20 shows a process flow diagram for another exemplar craft inspection process, according to another aspect of the present teachings.

### DETAILED DESCRIPTION

In the following description, numerous specific details are set forth in order to provide a thorough understanding of the present invention. It will be apparent, however, to one skilled in the art that the present invention is practiced without limitation to some or all of these specific details. In other instances, well-known process steps have not been described in detail in order not to unnecessarily obscure the invention.

Robot systems and methods of the present teachings are preferably contained inside or carried out in a craft inspection facility. The craft inspection facility preferably includes walls, a ceiling, and a floor, as well as a door entrance to receive a craft. The craft may include one member chosen from a group comprising an aircraft, an airplane, a boat, a submarine, a bicycle, a car, a truck, a bus, a motorcycle, a train, a ship, a watercraft, a sailcraft, a hovercraft and a spacecraft.

The craft inspection facility may utilize concrete or lead lining as shielding to attenuate the emission of radiation to adjacent units within the facility and to the outside of the facility. In certain embodiments of the present arrangement, various safety measures may be implemented. By way of example, interlocks are provided to prevent the emission of radiation when personnel might be endangered because, for example, a door to a room containing excessive amounts of radiation is opened. Other measures, such as key controls and password authentication, may be provided to prevent emission of radiation or other potentially hazardous activities, such as motion of robotic systems, without approval of authorized personnel. Radiation monitoring and alarm systems are preferably provided to detect abnormal radiation levels and provide warning.

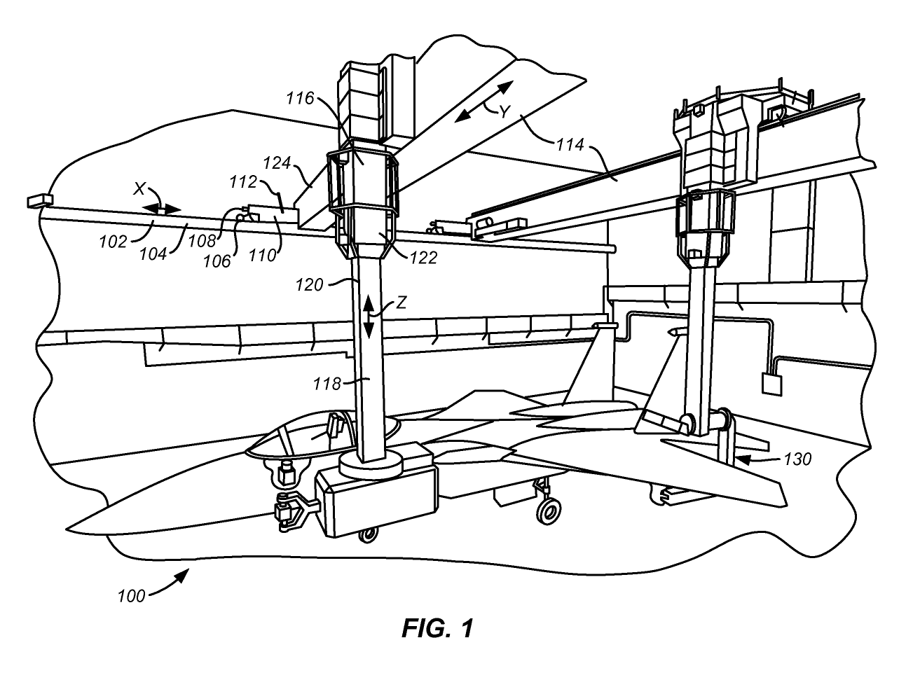

A craft inspection facility designed for inspecting crafts may be referred to as a facility unit. FIG. 1 shows a facility unit 100, according to one aspect of the present teachings. Facility unit 100 includes one or more overhead robot systems 124. In FIG. 1, a pair of parallel runways 102 is provided along an upper portion of the two walls extending in the X-direction inside facility unit 100. A rail 104, disposed on one of the runways 102, facilitates movement of one or more overhead robot systems 124 along its length, which extends in the X-direction. A beam 114 disposed perpendicular to runways 102 facilitates movement of one or more overhead robot systems 124 along its length, which extends in the Y-direction.

In the configuration shown in FIG. 1, overhead robot 124 is situated on an overhead carriage 116 (which may be thought of as a trolley). Overhead carriage 116 moves along a length of beam 114 and provides movement of overhead robot 124 in the Y-direction. Overhead carriage 116 may traverse the length of beam 114 between bridge end trucks 110.

Beam 114, with overhead robot 124 secured thereon, is capable of movement on rail 104. To this end, bridge end trucks 110, positioned at or near ends of beam 114, run parallel to rails 104 and mobilize overhead robot system 124 along the entire length of rail 104. A pair of wheels 106, installed on either end of bridge end truck 110, rides on rails 104. Wheels 106 are designed to support bridge end trucks 110 and reduce friction as they travels along rail 104. Shock absorbers 108 on bridge end trucks 110 prevent beam 114 from striking walls at the fore and aft end of the rails of facility unit 100.

To move toward and retract away from a craft undergoing inspection, overhead robot 124 is capable of movement in a third linear direction (i.e., along Z-axis). Movement along the Z-direction offers several functional capabilities. By way of example, movement in the Z-direction allows an NDI system to examine a craft's component and/or a sub-component from a certain desired distance (also referred to as “the stand-off distance”) away from that component and/or sub-component. As another example, movement of the NDI system in the Z-direction allows inspection of contours of a craft that vary along this direction.

In one embodiment of the present teachings, overhead carriage 116 is equipped with a telescoping mast 118 to provide a large range of motion in the Z-direction. Mast 118 includes a plurality of tubes that move telescopically and are capable of supporting a large amount of weight. By way of example, telescoping mast 118 includes an outer tube 122 and an inner telescoping tube 120. Inner telescoping tube 120 retracts or extends from outer tube 122 to move toward or away from a craft undergoing inspection.

According to the arrangement shown in FIG. 1, overhead robot system 124 resembles an overhead crane that operates within a facility unit and above a craft that is subject to NDI inspection. As described above, overhead robot system 124 is capable of moving in three linear directions (i.e., along X, Y and Z-axes). Movement in three linear directions allows overhead robot system 124 to maneuver to any desired area within a facility unit (preferably using X-axis and Y-axis) and position an NDI system proximate to the craft (preferably using Z-axis).

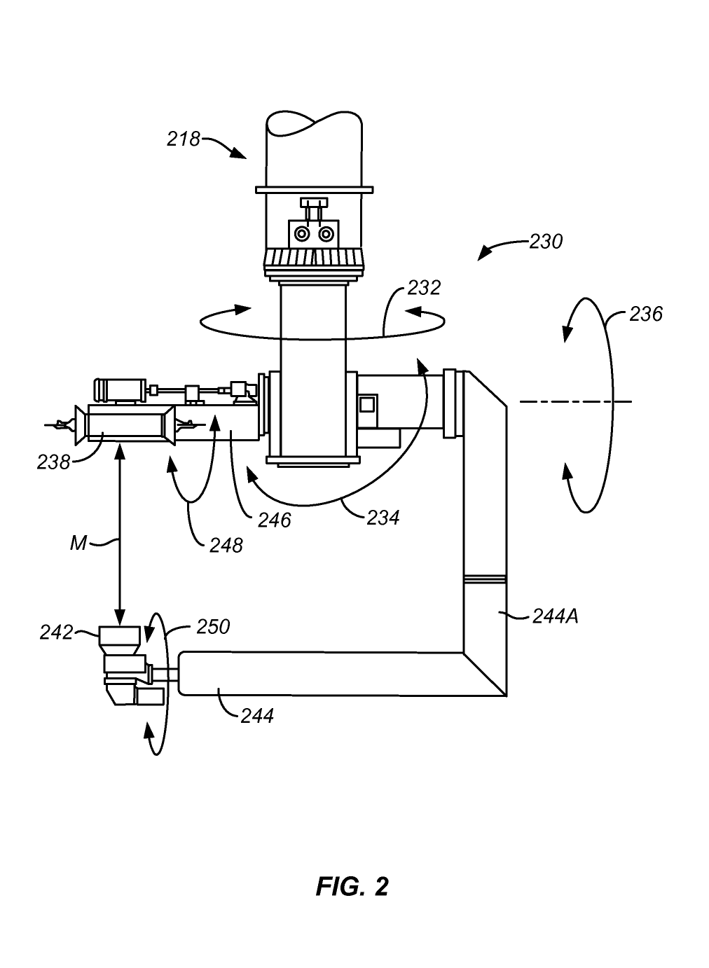

Movement of an overhead robot 124 is also possible in other directions, commonly referred to in the art as pitch, roll and yaw. These movements are explained in greater detail below with reference to a yoke 230 of FIG. 2. As shown in FIG. 1, an overhead robot associated with realtime X-ray includes an inspection yoke 130 (which is similar to yoke 230 in FIG. 2), which facilitates movement in these directions. According to the embodiment shown in FIG. 1, inspection yoke 130 is mounted to the bottom of mast 118.

Overhead robot system 124 facilitates an NDI and testing method to inspect and test craft components and/or sub-components in preferably a non-destructive manner. A system that implements NDI and testing method is referred to as an NDI system. An NDI system may include any one inspection and testing method chosen from a group comprising X-ray, ultrasonics, thermography, holography, shearography and neutron radiology. As a result, inside facility unit 100, overhead robots associated with different types of NDI systems may be made available and, if needed, to operate simultaneously. In other words, overhead robot 124 may be associated with a laser UT or thermography NDI systems, for example, and need not be associated with realtime X-ray. Representative X-ray methods and systems contemplated in the present arrangements include backscatter X-ray, digital plate X-ray, realtime X-ray, reverse geometry X-ray and CT X-ray. Representative ultrasonics methods and systems contemplated in the present arrangements include laser ultrasonics, plasma ultrasonics and water-jet squirter system ultrasonics.

FIG. 2 shows certain major components of a yoke 230 in greater detail. Yoke 230 may be designed to support an imaging device during craft inspection. In one embodiment, yoke 230 is a C-shaped structure attached to the bottom of mast 218 with an adjustable mouth “M” that spans the gap between a source 238 and a receiver 242.

As shown in FIG. 2, source 238 is mounted on a top support 246 of yoke 230 and an image receiver 242 is mounted on a bottom arm 244 of the yoke. In one embodiment of the present teachings, top support 246 and bottom arm 244 may be extended telescopically (i.e., horizontally) to adjust to a throat depth of yoke 230. This allows an imaging device to reach a craft component and/or sub-component that is away from an edge of a craft. In another embodiment of the present teachings, the adjustable mouth “M” between source 238 and receiver 242 may be increased by telescoping (vertically) bottom arm 244. Such ability to adjust mouth “M” also allows an overhead robot (e.g., overhead robot 124) to examine a component and/or a sub-component of varying thicknesses.

Yoke 230 inspects components and/or sub-components of a craft in three-dimensional space (where the part shape varies in X, Y and/or Z directions) and in angle space. In angle space, a first rotational axis 232 (i.e., Yaw) rotates inspection yoke 230 in a horizontal plane at the bottom of mast 218. A second rotational axis 236 (i.e., Pitch) pivots inspection yoke 230 in a vertical plane at the bottom of mast 218. A third rotational axis 234 (i.e., Roll) rotates inspection yoke 230 in a plane, which is oriented perpendicular to the horizontal axis and the movement of the yoke is offset from the vertical plane. Bottom arm 244 is also capable of movement along a rotational axis 250, which is substantially similar to rotational axis 236; and top support 246 is capable of movement along a rotational axis 248, which is substantially similar to rotational axis 236.

The present teachings recognize that yoke 230 is not capable of inspecting certain craft components and/or sub-components. In some instances, for example, the C-shaped structure of the yoke collides with an edge of a component and/or the sub-component when the yoke attempts to access certain deeper areas of a relatively large component and/or sub-component. At least for this reason and other reasons, e.g., for accomplishing high throughput during the inspection process, the present teachings offer underside inspection capability inside the facility unit.

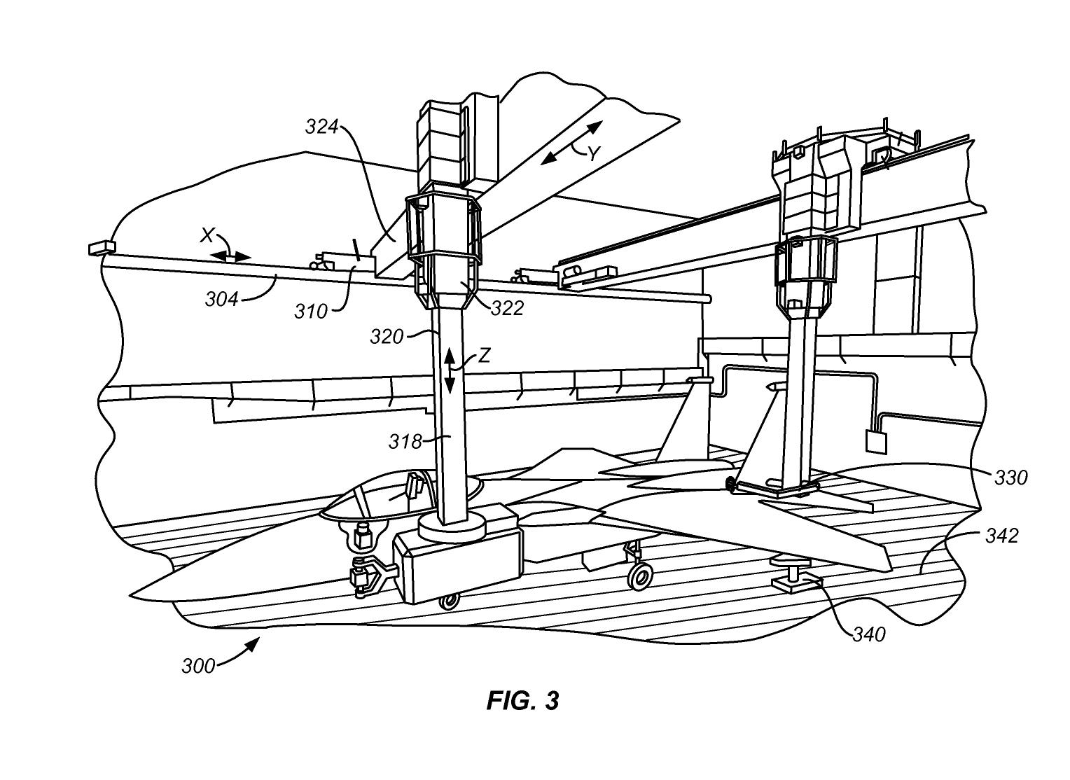

FIG. 3 shows a craft inspection facility 300, according to a preferred embodiment of the present teachings, for conducting underside and overhead inspections of a craft component and/or sub-component. Inspection facility 300 is substantially similar to inspection facility 100 of FIG. 1, except inspection facility 300 includes provisions for underside inspection, such as rails 342 and an underside robot 340 associated with an NDI method. In the arrangement of FIG. 3, underside robot 340 is supported on rails 342.

Inspection facility 300 includes an overhead robot 324, rails 304, bridge end truck 310, a mast 318, an outer tube 322 and an inner telescoping tube 320, which are substantially similar to their counterparts of FIG. 1, i.e., overhead robot 124, rails 104, bridge end trucks 110, mast 118, outer tube 122 and inner telescoping tube 120. As a result, one or more overhead robots 324 are also capable of movement in at least three linear directions (i.e., along X, Y and Z-axes), and movement in three rotational directions (i.e., pitch, roll and yaw). FIG. 3 shows an underside robot 340 and another overhead robot 330, which does not have its yoke around a component and/or sub-component.

According to FIG. 3, due to the presence of underside robot 340, it is not necessary to have a bottom arm (e.g., bottom arm 244 of yoke 230 in FIG. 2) positioned around a component and/or sub-component. Rather, it is preferable to have bottom arm 244 articulated ninety degrees so that it is out of the way. In this configuration, a top support of overhead robot 324 (which is similar to top support 246 of inspection yoke 230 of FIG. 2) may have secured thereon an image source (e.g., source 238 of FIG. 2), and underside robot 340 may have disposed thereon an image receiver (e.g., receiver 242 of FIG. 2). During inspection, if X-ray is required, overhead robot 324 provides the benefit of a source for imaging, and underside robot 340 provides the benefit of a receiver to enable imaging of the component and/or sub-component undergoing inspection.

The present teachings also recognize that to accomplish imaging by realtime X-ray, as described above, it is not necessary for overhead robot 324 to provide the benefit of a source and for underside robot 340 to provide the benefit of receiver. Rather, instead of articulating bottom arm 244 in FIG. 2 out of the way, receiver 242 is rotated 180 degrees at rotational axis 250. In this configuration, bottom arm 244 in FIG. 2 may provide the benefit of a receiver (which is similar to receiver 242 of yoke 230 of FIG. 2), and underside robot 340 may provide the benefit of a source.

The present teachings offer underside robot 340 for use in NDI methods other than X-ray. By way of example, underside robot 340 may facilitate inspections using laser ultrasonics methods.

Underside robot 340, which may be a ground-based six-axis pedestal robot, is capable of movement to a desired pinpoint destination for inspection. In one embodiment of the present teachings, a desired inspection location may be a location of component and/or sub-component of a craft undergoing inspection. As will be described in greater detail below in connection with FIG. 6, the location of a component and/or sub-component within a facility unit (e.g., facility unit 300 of FIG. 3) may be determined using overhead robot 324. Component and/or sub-component location obtained by an overhead robot 324 may be conveyed to one or more computer systems (e.g., one or more of controller and client servers 602 of FIG. 6). Controllers and client server may be capable of controlling both an overhead robot inspection system and an underside robot inspection system. Controllers and client server is capable of translating overhead robot 324 location information to underside robot coordinates (sometimes referred to as “facility coordinates”). Using the underside robot coordinates, underside robot 340 may move to a predetermined X and Y location. Such movement may be accomplished using one or more rails.

A computer is just one example of a mechanism to transfer overhead robot 324 coordinates to underside robot coordinates 340. Other recording and transferring mechanisms can be used such as: personal computer, servers, cloud based servers, file servers, database servers, processors, controllers and storage media. An example of one such mechanism is detailed in FIG. 6 and described below.

After underside robot 340 receives a desired inspection location, underside robot 340 may move to that location. In certain embodiments of the present teachings, underside robot 340 utilizes one or more rails to reach a desired inspection location. One or more rails are disposed on the floor of a facility unit and extend along a dimension of facility unit. Underside robot 340 can be moved onto any one or more rails, which allows underside robot 340 to maneuver within inspection facility unit. A rail drive subsystem proximate to one or more rails mobilizes underside robot 340 to a predetermined inspection location.

The use of one more rails, however, is not the exclusive method in which to position underside robot 340 to a predetermined location. For example, global positional systems, ultrasound and lasers may well be used to determine the exact location of the underside robot 340 within the facility unit and/or instruct underside robot 340 to move to a predetermined location.

In one embodiment of the present teachings, a rail drive subsystem includes one member chosen from a group comprising a motor, a rack and pinion drive system, a screw-drive system, an encoder and a resolver. The present teachings contemplate still other modes of mobilization. Ground base robot 340 may be mobilized in any manner, e.g., using cables and pullies, and a mechanical or electromagnetic hook-up to a cart or a positioner containing underside robot 340.

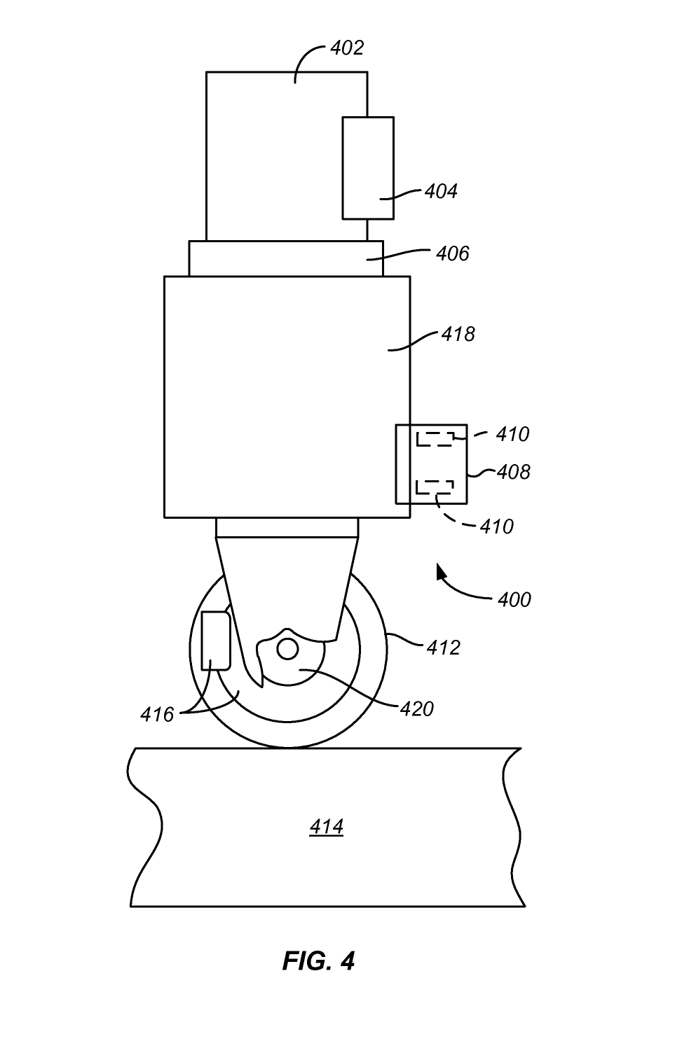

According to one embodiment of the present teachings shown in FIG. 4, an overhead robot (e.g., overhead robot 124 of FIG. 1 and overhead robot 324 and 330 of FIG. 3) uses a drive subsystem 400 to move bridge end trucks (e.g., bridge end truck 110 of FIG. 1 and bridge end truck 310 of FIG. 3) along rails (e.g., rail 104 of FIG. 1 and rail 304 of FIG. 3). Drive subsystem 400 includes a variable-speed DC motor 402, a gearbox 418, and an encoder 406. Power to turn the motor (thus moving the robot) is supplied by a controller 404. Encoder 406 instructs controller 404 regarding distance of travel for each wheel of a robot. A resolver 408 communicates with encoder 406 through controller 404 and adjusts power to motor 402 to keep the movement along rails equal in distance traveled. Drive subsystem 400 includes a solenoid energized electric disc brake 416, which keeps the robot in a frozen position whenever controller 404 is not supplying power to motor 402. For each direction robot is capable of moving, there is also an absolute-positioning resolver 408 that instructs controller 404 regarding the robot's location via encoder 406. Limit switches 410 inside resolver 408 prevent the motor 402 from driving wheeled drive subsystem 400 beyond its end of travel. Heavy-duty frictionless bearings 420 are used throughout, in accordance with one embodiment of the present teachings, to maximize system reliability.

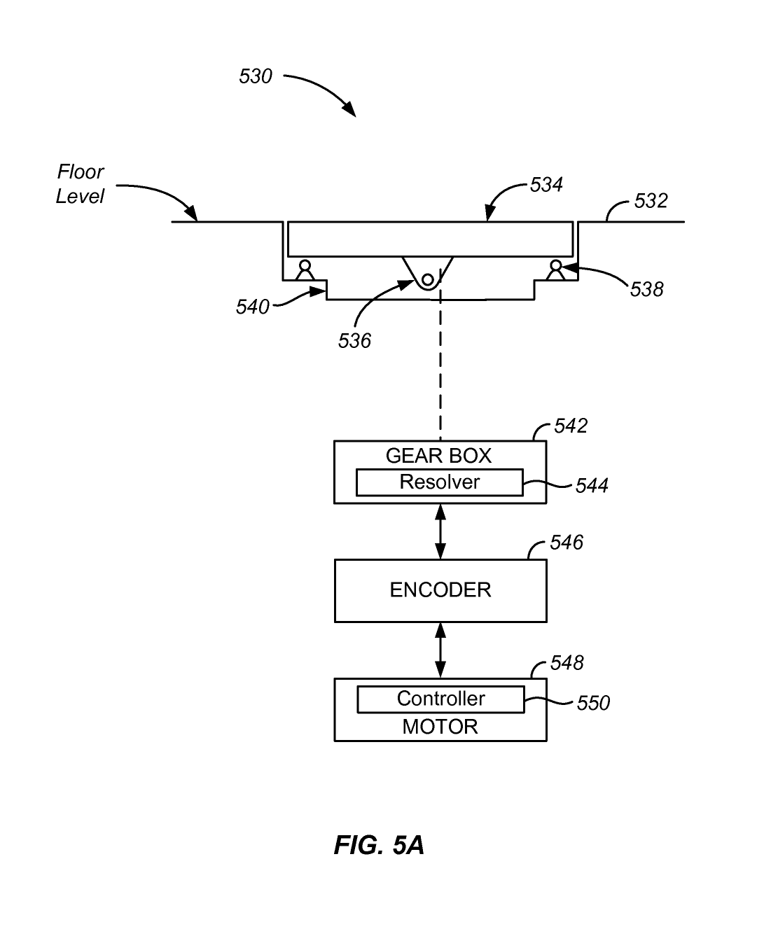

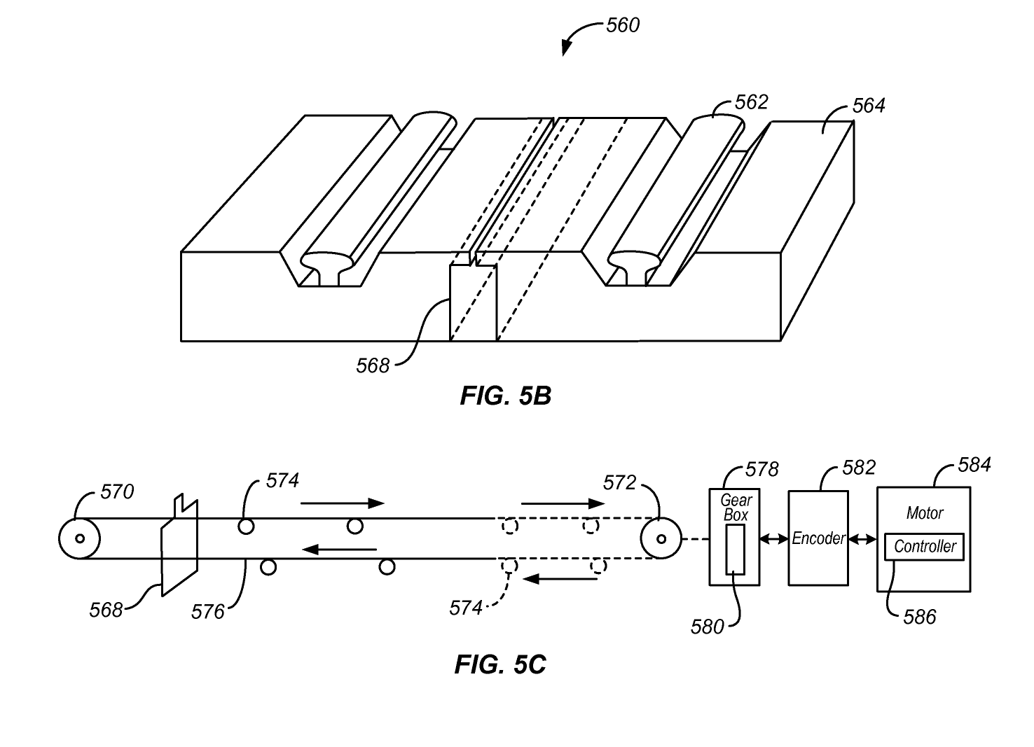

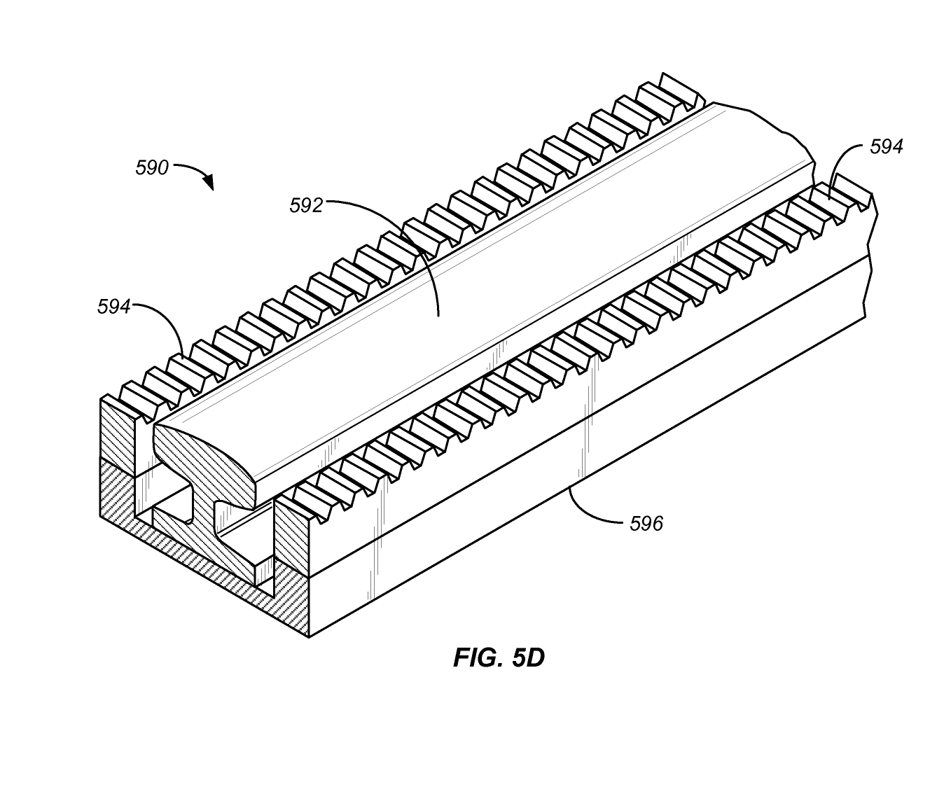

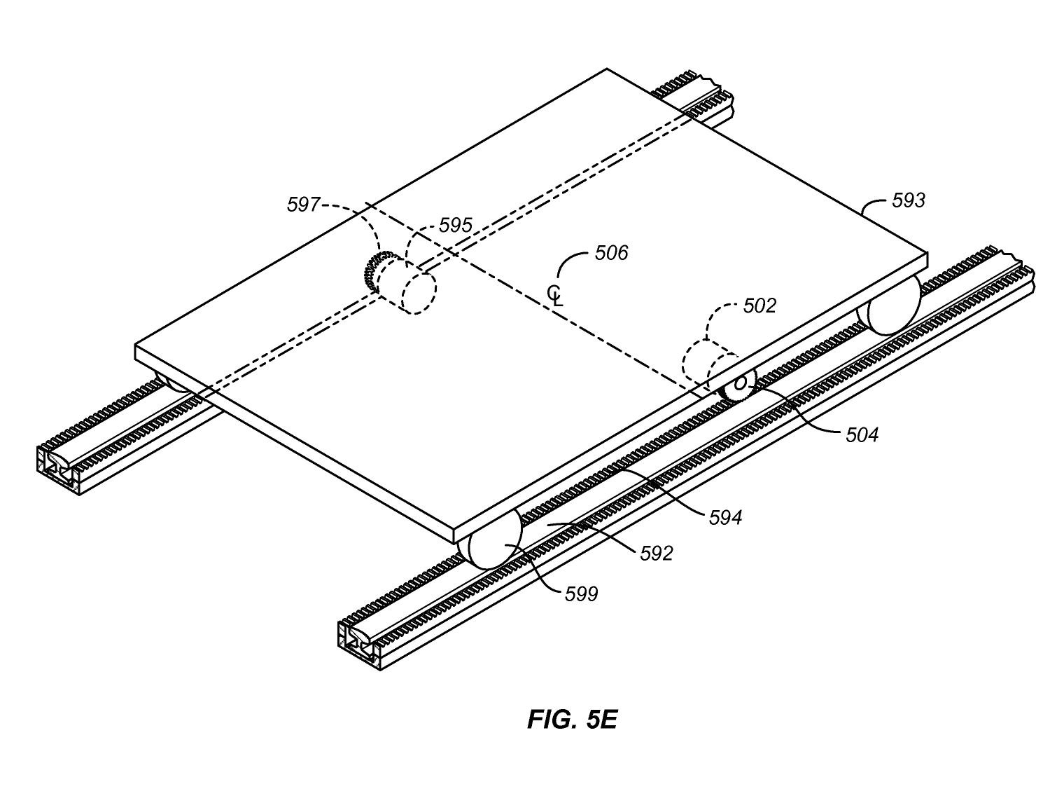

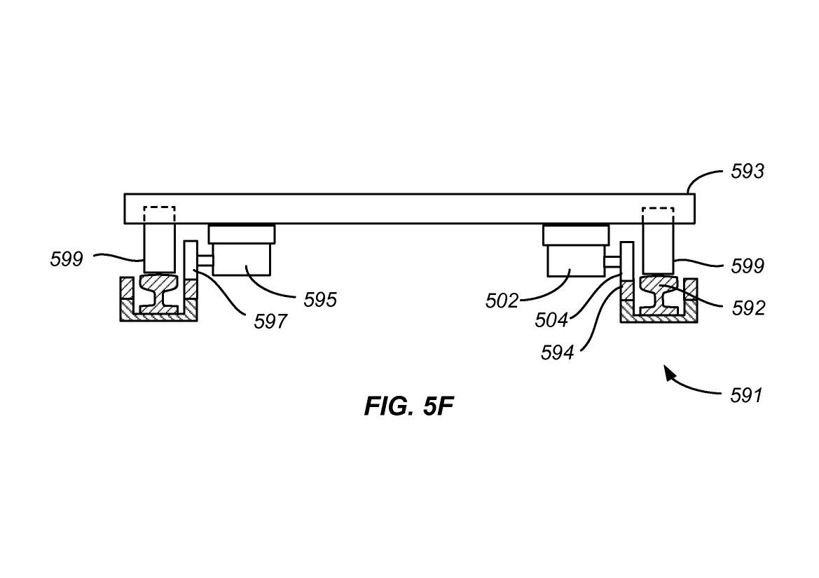

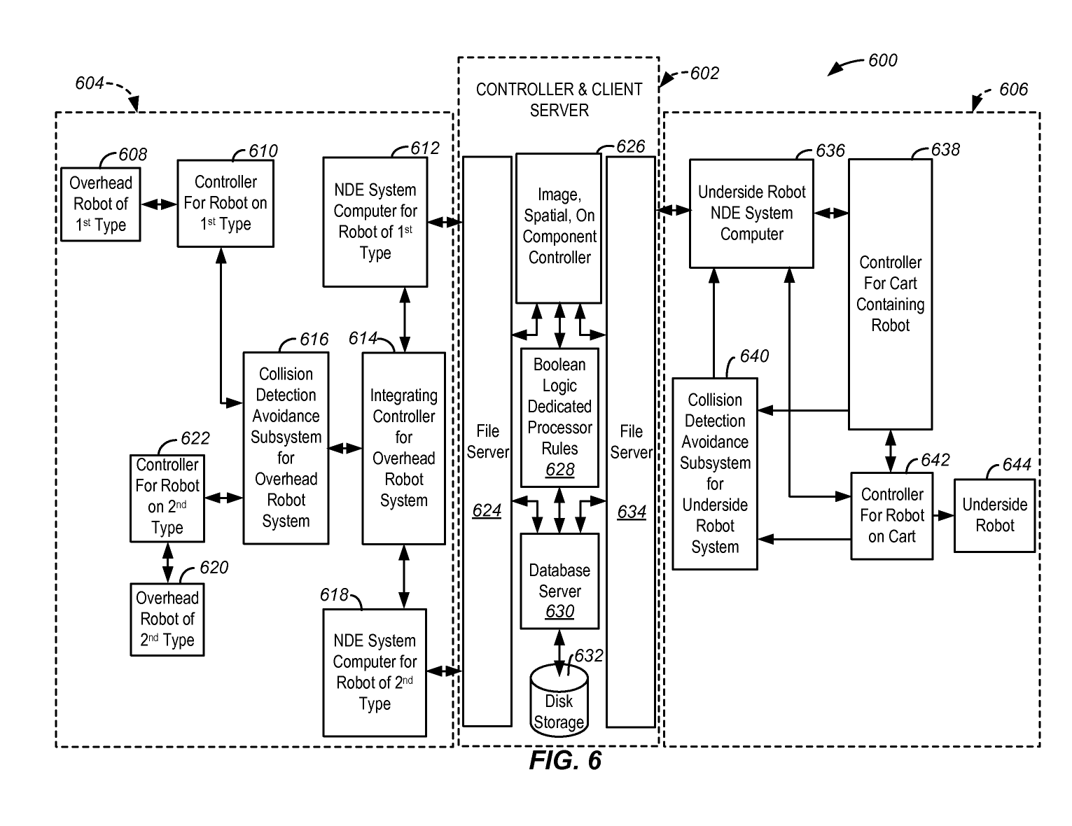

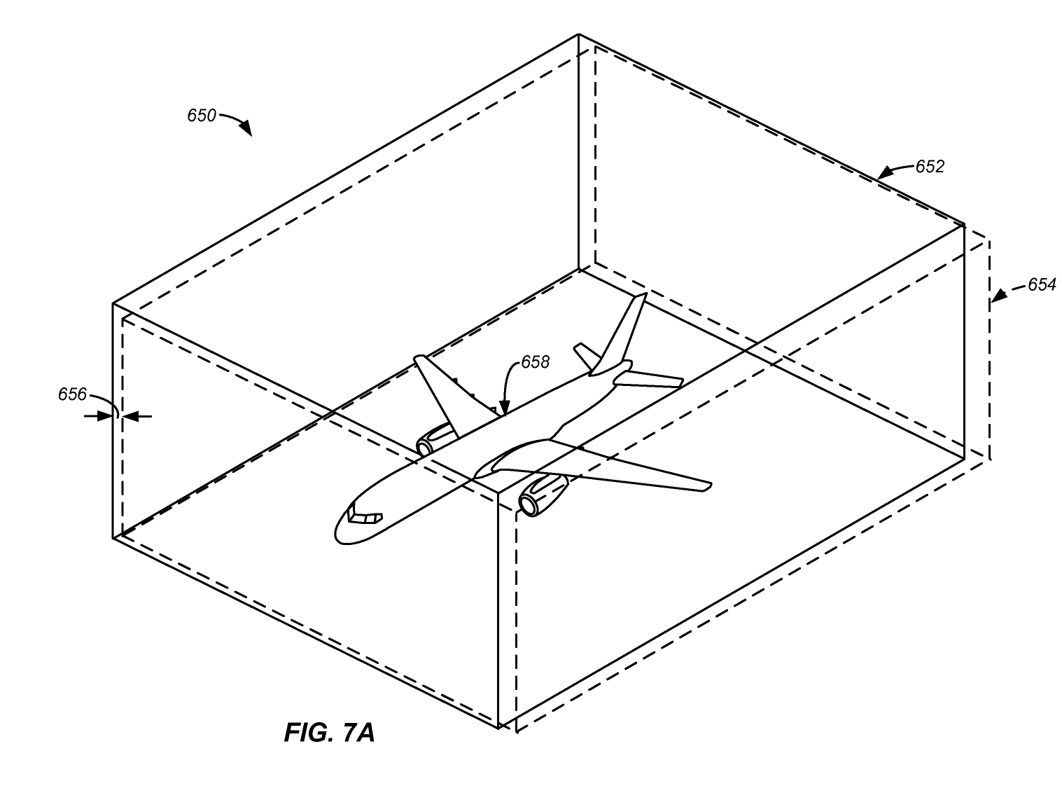

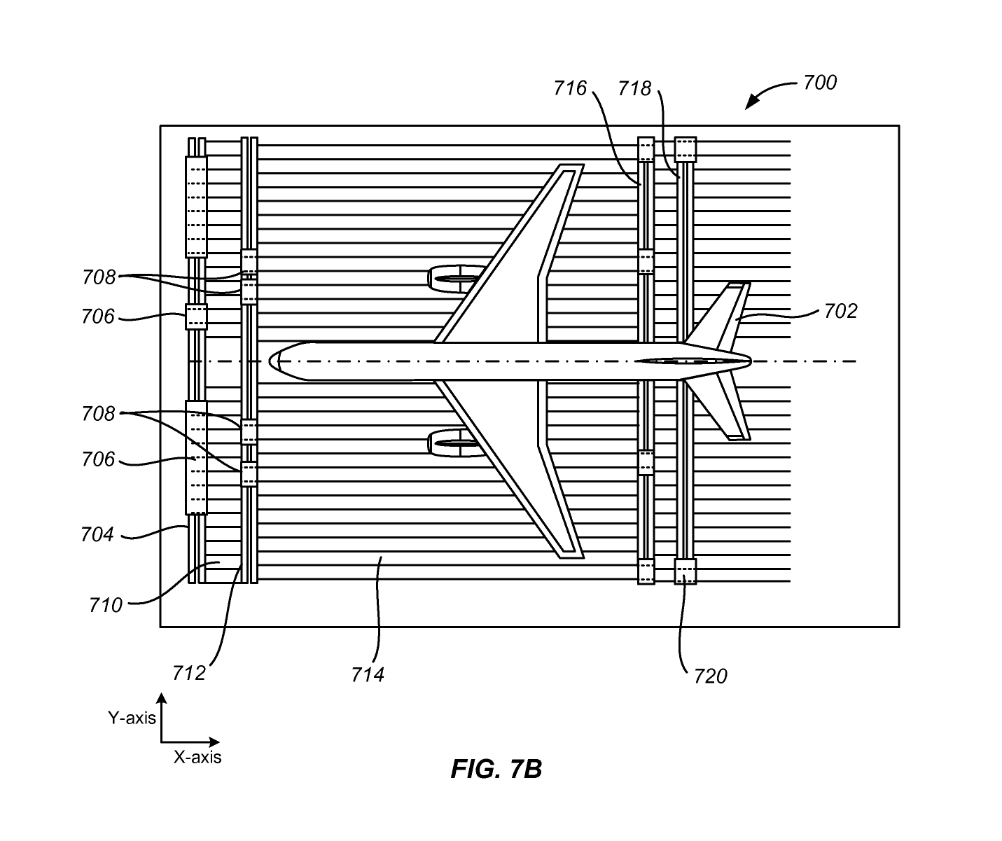

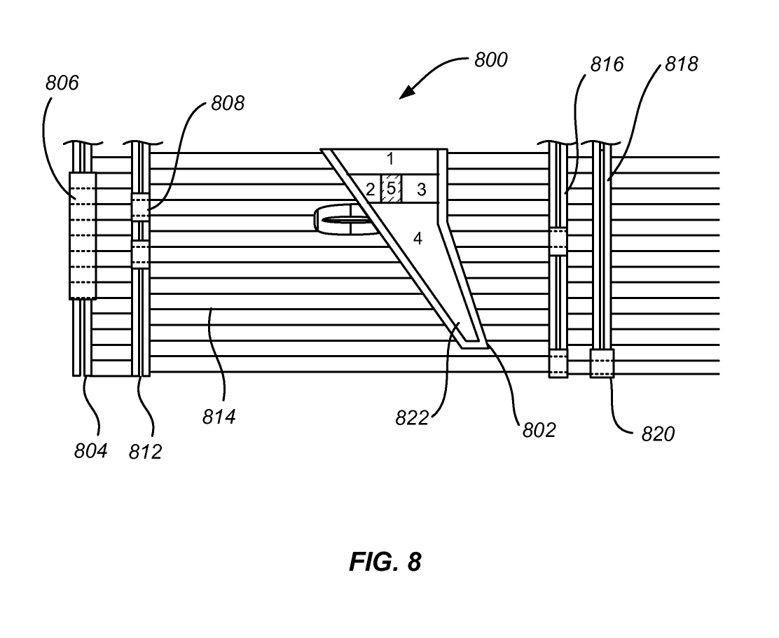

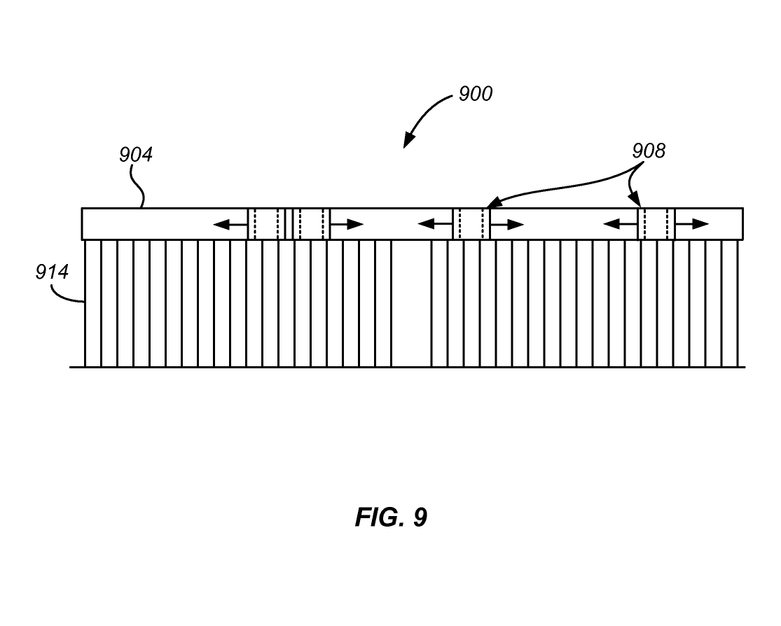

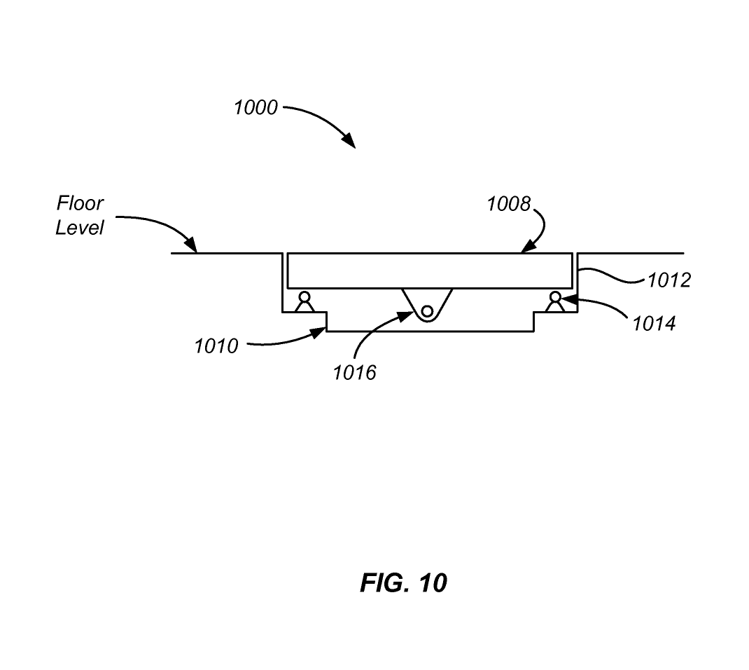

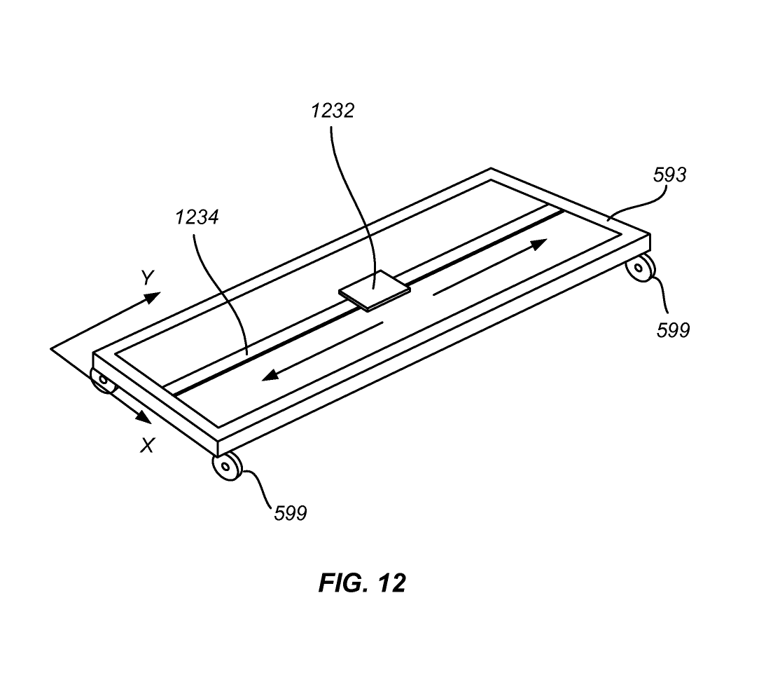

The present teachings also provide drive subsystems for an underside robot (e.g., underside robot 340 of FIG. 3). As is explained later in connection with FIGS. 9-12, movement of underside robots is facilitated by movement of an index positioner (e.g., index positioner 1008 of FIG. 10) on an indexing bed (e.g., bed 1012 of FIG. 10), movement on a cart (e.g., a cart 593 of FIG. 5E) on one or more rails (e.g., rails 714 of FIG. 7B) and of the index positioner, and movement of robot on a lower carriage (e.g., lower carriage 1232 of FIG. 12). In the event a pedestal robot is being used for underside inspection, six degrees of movement by the pedestal robot facilitate location of an underside robot to an inspection destination. Six degrees of movement of the pedestal robot aside, one of the index positioner, the cart and the lower carriage is designed to mobilize the underside robot at various instances during the inspection, and during such instances, a different drive subsystem may be used to advance the underside robot to its inspection destination. By way of example, a bed drive subsystem advances an index positioner with the underside robot secured thereon. As another example, an index positioner's drive subsystem advances a cart (with underside robot) from indexing bed to one or more selected rails. As yet another example, a rail drive subsystem advances the cart on the rails. As yet another example, a cart drive subassembly advances the lower carriage with the underside robot. These various drive subsystems are explained in greater detail in connection with FIGS. 5A-5F. The present invention also recognizes that overhead robots (e.g., overhead robots 324 and 330 of FIG. 3) may be mobilized to their inspection destination using the same or similar drive subsystems described in connection with the movement of underside robots.

FIG. 5A shows a bed drive subsystem 530 for mobilizing an index positioner 534 on an indexing bed 540 to a predetermined location. A predetermined location may be a location on indexing bed 540 that allows a robot to select one or more rails (e.g., rails 592 of FIG. 5E) for an inspection of a component and/or sub-component of a craft. A bearing surface 538 disposed below index positioner 534 may prevent side-to-side movement of the index positioner and the underside robot (not shown to facilitate illustration) secured thereon, and may also allow for continuous movement of the index positioner on the indexing bed. In one embodiment of the present teachings, bearing surface 538 includes linear roller bearings. By way of example, Thomson RoundWay® Linear Roller Bearings, which are commercially available from Thomson Industries, Inc., of Washington D.C., represent a preferred embodiment of bearing surface 538. Although indexing bed 540 is shown to be recessed inside a floor surface 532 of an inspection facility unit (e.g., facility unit 300 of FIG. 3), it is not so limited. In accordance with other embodiments of the present arrangement, indexing bed 540 may be raised or even (i.e., at substantially the same height) relative to floor surface 532.

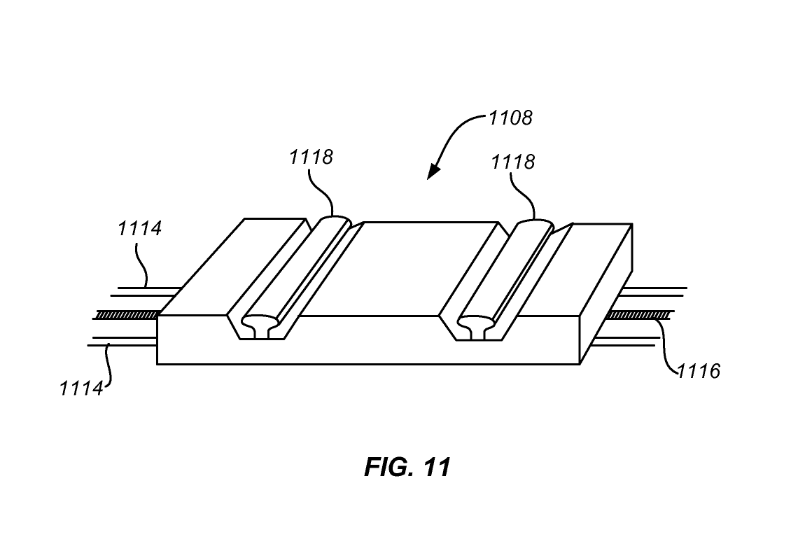

Index positioner 534 may also include a provision for its mobilization on indexing bed 540. To this end, the embodiment of FIG. 5A shows a location 536 where a threaded shaft (e.g., threaded shaft 1116 of FIG. 11) is disposed, preferably a length of indexing bed 540, to mobilize index positioner 534. According to a preferred embodiment of the present arrangement, index positioner 534 includes a motor-driven ball screw that functions in conjunction with the threaded shaft to advance the index positioner on the bed. The present invention recognizes that although a single location 536 for one threaded shaft is shown in FIG. 5A, one or more such locations may be present to accommodate one or more threaded shafts, each of which preferably facilitates mobilization of a single index positioner on indexing bed 540. In this manner, the present teachings provide mobilization of multiple index positioners (e.g., index positioners 708 of FIG. 7B) on indexing bed 540 of FIG. 5A. As a result, indexing bed 540 may have space defined therein to house multiple bed drive subsystems (which include multiple threaded shafts) to mobilize multiple index positioners.

An exemplar bed drive subsystem, like overhead drive subsystem 400 of FIG. 4, uses a tracking mechanism to determine the exact location of index positioner 534 on indexing bed 540 of FIG. 5A. The tracking mechanism ensures that index positioner 543 does not misalign with respect to indexing bed 540. The above-mentioned motor-driving ball screw comprises a tracking mechanism including controllers, encoders, and resolvers that are discussed below in greater detail. FIG. 5A shows these components of bed drive subsystem 530 in a block diagram form to simplify illustration and facilitate discussion. According to this figure, the threaded shaft is communicatively coupled, preferably by a mechanical connection, to a gear box 542, which includes a resolver 544. Gear box 542 is communicatively coupled to an encoder 546, which is, in turn, communicatively coupled to a motor 548. Motor 548 includes a controller 550. The term “communicatively coupled,” as used herein, refers to a connection, which may be direct or indirect, unidirectional or bidirectional and allowing flow of energy and/or information (such as signals).

In one present arrangement, controller 550 receives instructions regarding mobilizing index positioner 534 to a predetermined location (which may be thought of as an intermediate location on the index positioner's path to an inspection destination) on indexing bed 540 from a computer system (e.g., controller and client server 602 of FIG. 6). Controller 550 may instruct a motor-driving ball screw to rotate (i.e., energizing motor 548) around the threaded shaft, causing index positioner 534 to advance on indexing bed 540. At this stage, encoder is capable of measuring the motor-driving ball screw's linear distance of travel on the threaded shaft. Furthermore, resolver 544 may receive from encoder 546 its measurement of the linear distance. Resolver 544, however, is also capable of measuring the linear distance traveled by index positioner 534 on indexing bed 540 using rotational measurement from its vantage point (on index positioner 534). As a result, resolver 544 is able to compare its measurement with that obtained from encoder 546. If it determines that motor-driven ball screw is rotating to move the cart to a predetermined location, resolver 544 instructs controller 550 to move a given distance down indexing bed 540. When index positioner 536 arrives at a predetermined location for inspection, for example, then controller 550 de-energizes the motor-driving ball screw to stop index positioner 534 from advancing any further.

In other words, gear box 542, resolver 544, encoder 546, motor 548 and controller 550 of FIG. 5A function in a manner that is substantially similar to their counterparts in FIG. 4, i.e., gear box 418, resolver 408, encoder 406, motor 402 and controller 404. Regardless of the manner in which index positioner is mobilized in a controlled manner in indexing bed 540, the present teachings recognize that index positioner 534 aligns to one or more rails (e.g., rails 714 of FIG. 7A) before arriving at the predetermined location.

According to the present teachings, a variety of different methods or different types of drive subsystems may be used for mobilizing index positioner 534 on indexing bed 540. In addition to the mechanism described above in connection with FIG. 5A, index positioner 534 may be mobilized on indexing bed 540 using a rack and pinion drive system or a motor-driven cable system.

FIG. 5B shows an exemplar configuration of a motor-driven cable system to mobilize a cart (e.g., cart 593 of FIG. 5E; not shown in FIG. 5B to simplify illustration and facilitate discussion) off an index positioner 560 (which is substantially similar to index positioner 534 of FIG. 5A) and onto one or more rails (e.g., rails 714 of FIG. 7B) that are disposed on a floor surface of a facility unit (e.g., facility unit 700 of FIG. 7). As shown in FIG. 5B, index positioner 560 includes a surface 564, rails 562 and a channel 568 defined therein. Inside an inspection facility unit (e.g., facility unit 700 of FIG. 7B), surface 564 is preferably flush with a floor surface of the facility unit, allowing rails 562 on index positioner 560 to effectively align with rails (e.g., rails 714 of FIG. 7B) of the facility unit.

In the preferred arrangement of FIG. 5B, channel 568 houses the motor-driven cable system to mobilize the cart from rails 562 of index positioner 560 onto rails of a facility unit. The motor-driven cable system includes pulleys 570 and 572, a cable 576, and supports 574. Cable 576 wraps around pullers 570 and 572, which is driven by a motor 584. Supports 574 ensure that cable 576 stays in place as it travels from one pulley to the other.

In this arrangement, the motor-driven cable system is parallel to one or more index positioner rails 562, and a connection (e.g., mechanical or electromagnetic) between the motor-driven cable system and an underside portion of index positioner 560 moves a cart off index positioner 560 to rails of a facility unit.

The motor-driven cable system includes a tracking mechanism that has a gear box 578 with a resolver 580, an encoder 582, and motor 584 with a controller 586. According to preferred embodiments of the present teachings, gear box 578, resolver 580, encoder 582, motor 584 and controller 586 of FIG. 5C function in a manner that is substantially similar to their counterparts in FIG. 5A, i.e., gear box 542, resolver 544, encoder 546, motor 548 and controller 550 of FIG. 5A.

In an alternate embodiment of the present teachings, a cart is mobilized off the index positioner rails onto the facility unit's rails by one or more racks and an associated pinion (hereinafter “rack and pinion system”). A lower carriage (e.g., lower carriage 1232 of FIG. 12) may similarly use the rack and pinion system to mobilize on the cart to travel towards an inspection destination.

To this end, FIG. 5D shows a portion of a rack and pinion drive subsystem 590 (hereinafter referred to as the “rack and pinion system 590”). Rack and pinion system 590 includes racks 594 disposed parallel to rail 592. A foundation 596, preferably made from metal, supports racks 594 and rail 592. In this embodiment, racks as contemplated in one arrangement are communicatively coupled to a tracking mechanism (which includes an encoder, a resolver and a motor similar to those shown in FIGS. 5A and 5C) and is discussed below in greater detail in connection with FIGS. 5E and 5F.

Although rack and pinion system 590 shows racks 594, the present teachings recognize that alternate embodiments do not include racks, and that rail 592 (which appear relatively smooth in FIG. 5D) may be jagged like racks 594 making rail 592 a rack. As a result, in this embodiment, the rail has a dual purpose of supporting movement of a cart or lower carriage, for example, and also of facilitating communication with a tracking mechanism.

Regardless of whether a rack is present or absent from the drive subsystem, a connection (e.g., mechanical or electromagnetic) from the cable portion of the drive subsystem to the cart or the lower carriage facilitates movement of an underside robot (on the cart or the lower carriage, respectively).

FIGS. 5E and 5F shows an exemplar detailed configuration of, among other things, the pinion portion of the rack and pinion system. A cart 593 includes wheels 599 and pinions 504 and 597. In an engaged position of the rack and pinion system, wheels 599 rest on the rail and a teeth-like structure of pinions 504 and 597 meshes with the jagged structure of their corresponding racks. In this configuration, a pinion engaged with a rack may be thought of as a rack and pinion mechanism. Pinion 504 is coupled to a motor 502 and pinion 597 is coupled to another motor 595. As shown in FIG. 5E, the position of motors 502 and 595 are offset from a centerline 506 of cart 593. These motors may be located below cart 593 and are part of or coupled to a tracking mechanism (similar to those discussed above in connection with FIGS. 5A and 5C). The offset position of the motors ensures that when a cart (e.g., cart 593 of FIG. 5E) mobilizes off an index positioner and onto rails on the floor surface of the facility unit, at least one rack and pinion mechanism is engaged at all times. In other words, if a portion of cart 593 including motor 595 has crossed over from the index position over to one or more rails, then motor 502 is in position to effectively drive off entire cart 593 from the index positioner onto the rails. To facilitate illustration, FIG. 5E shows an end view of cart 593 engaged with the rails on the floor surface of the facility unit or on the index positioner. Rack and pinion system as described in FIGS. 5E and 5F is not limited to mobilizing a cart on an index positioner's rails and/or on the facility unit's floor surface, rather, the present invention recognizes that such a system may facilitate mobilization of a robot in other configurations not described herein.

FIG. 6 shows a block diagram for an inspection control system 600, according to one present arrangement, for controlling movements of both one or more overhead robots and one or more underside robots. Inspection control system 600 allows, among other things, conveying information collected by an overhead robot with machine vision (e.g., overhead robot 608) to an underside robot (e.g., underside robot 644) to increase the throughput of the present craft inspection process. Inspection control system 600 includes a controller and client server 602 that is designed to control an overhead robot inspection system 604 and an underside robot inspection system 606. Controller and client server 602 is communicatively coupled to both inspection systems 604 and 606 such that controller and client server 602 is capable of receiving information from and transmitting information to both inspection systems.

Overhead robot inspection system 604 includes an overhead robot of the first type 608 with machine vision, a controller for the overhead robot of the first type 610 and a non-destructive evaluation (“NDE”) system computer for the overhead robot of the first type 612. Underside robot inspection system 606, which is explained below in greater detail, includes one or more underside robots and control provisions similar to overhead robot inspection system 604.

An integrating controller 614 is designed to control one or more overhead robots. Integrating controller 614 is capable of integrating information that is received from one or more overhead robots (in overhead robot inspection system 604) for controlling movement of those one or more overhead robots. In one embodiment of the present arrangement, integrating controller 614 is thought of as a master controller for overhead robot inspection system 604. According to one aspect of the present teachings, integrating controller 614 is communicatively coupled to controller and client server 602 so that information received from one or more overhead robots may be conveyed to underside robot inspection system 606 through controller and client server 602.

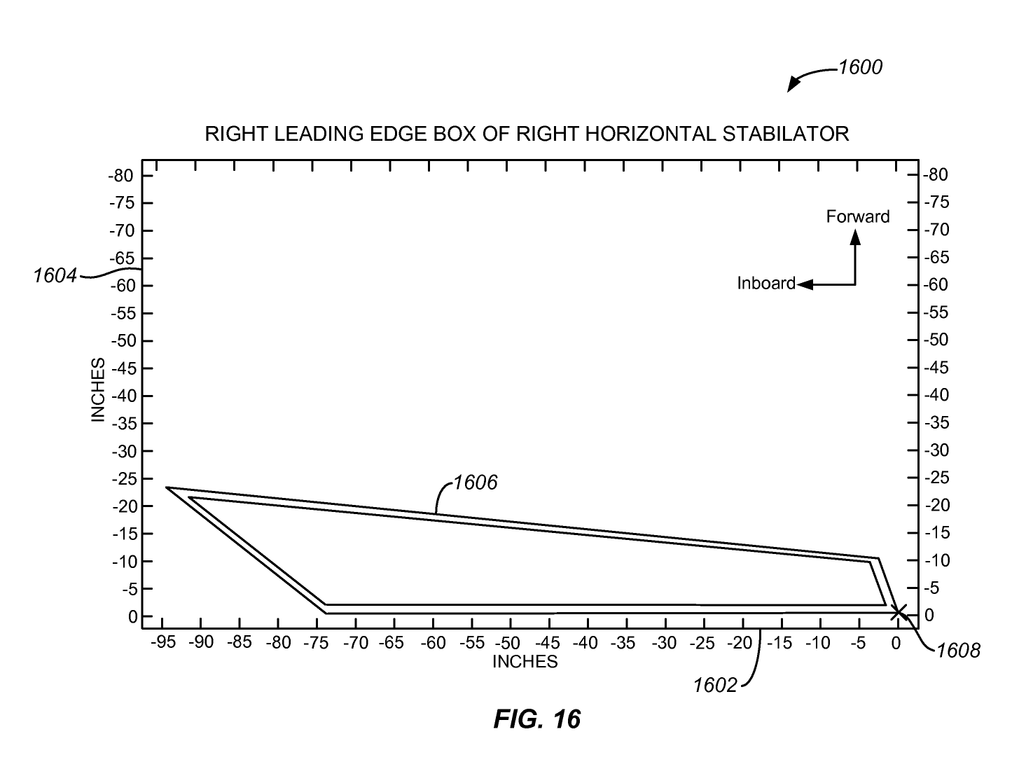

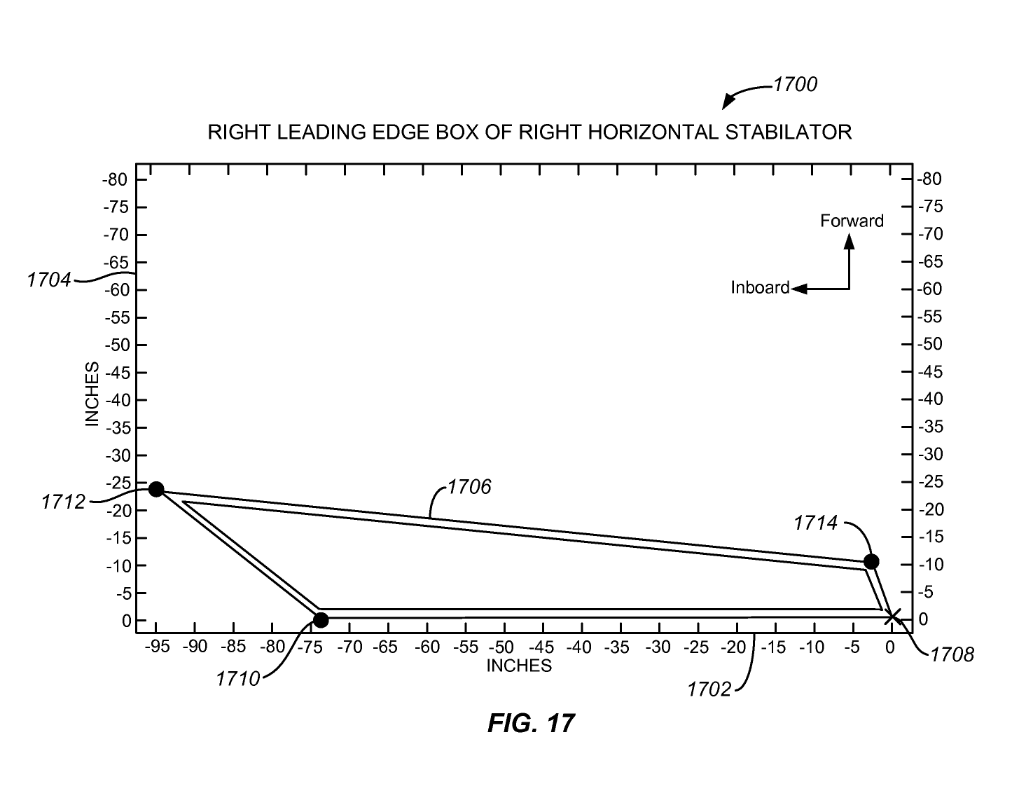

In certain instances, it is preferable to have location information from more than one type of overhead robot (e.g., robots 608 and 620) to properly control the movements of an underside robot (e.g., robot 644). In other instances, information from an overhead robot of a first type alone (e.g., robot 608) is sufficient to properly control the movement of the underside robot (e.g., robot 644) during inspection. An overhead robot of more than one type is not necessary to obtain all the information required for properly controlling the movement of the underside robot of the first type, if the overhead robot of the first type is associated with a X-ray NDI system, which is capable of not only determining the overhead robot's position in the X, Y and Z-directions, but also capable of determining certain scan plan information, such as angle of attack to a component and/or a sub-component of the craft undergoing inspection, stand-off distance to the component and/or the sub-component, and a point of origin (e.g., location of point of origin 1608 of FIG. 16) and one or more boundary coordinates (e.g., location of boundary coordinates 1710, 1712 and 1714 of FIG. 17) of the component and/or the sub-component. If the overhead robot of the first type, e.g., X-ray NDI system, is not capable of determining certain scan plan information, i.e., angle of attack, stand-off distance, a point of origin and one or more boundary coordinates, then more than one type of overhead robot is preferably included to obtain that scan plan information and thereby effectively control an underside robot's movement.

If it is deemed preferable to include more than one type of overhead robot to effectively provide information for control of an underside robot's movement, then overhead robot inspection system 604 of FIG. 6 may include an overhead robot of a second type 620 and provisions required to control an underside robot's movements. According to the exemplar arrangement of FIG. 6, overhead robot inspection system 604 includes an overhead robot of a second type 620, a controller for the overhead robot of the second type 622, and a non-destructive evaluation (“NDE”) system computer for the overhead robot of the second type 618.

Overhead robot inspection system 604 also includes an overhead collision detection avoidance subsystem 616 designed to avoid collision between a mobile overhead robot and a component and/or sub-component of a craft undergoing inspection and/or another robot (overhead or otherwise), which may or may not be mobile. The above-mentioned component and/or sub-component may or may not be of a variety (e.g., primarily a mechanical component) that undergoes structural inspection.

When overhead robot 608 is mobile (e.g., during an inspection process), it is communicatively coupled to various tracking mechanisms that provide it information regarding its location. By way of example, robot 608 receives information from an encoder associated with an overhead rail drive subsystem (e.g., drive subsystem 400 of FIG. 4) about its location along X-axis, receives information from an encoder associated with a beam and upper carriage drive subsystem (which is similar to dive subsystem 400 of FIG. 4, but rides on beam 114 of FIG. 1) about its location along Y-axis and receives information from a drive subsystem associated with a mast (e.g., 118 of FIG. 1) about its location along Z-axis. As another example, if robot 608 is a realtime X-ray NDI system, then robot 608 receives from a database server 630 scan plan information, e.g., angle of attack, stand-off distance, point of origin and boundary coordinates. Such information is stored in a database server 630 during development of a reference database for realtime X-ray and for a particular component and/or the sub-component of a craft that will be subject to inspection. Robot 608 is communicatively coupled to controller 610 such that any information provided to robot 608 is conveyed to controller 610, and vice-versa.

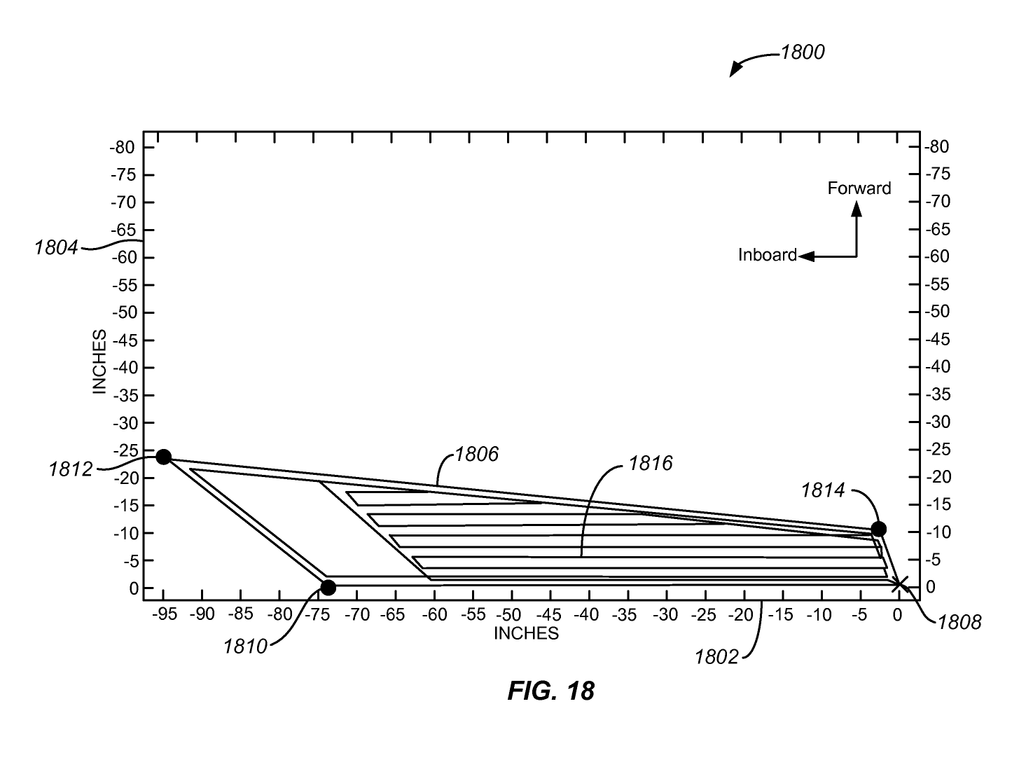

Controller 610 is capable of advancing information it receives to a collision detection avoidance subsystem 616, which ensures that during inspection, movement of robot 608 avoids collision with another robot and/or a component and/or a sub-component of a craft undergoing inspection. Collision detection avoidance subsystem 616 is communicatively coupled to integrating controller 614 such that information may be exchanged between subsystem 616 and integrating controller 614. Integrating controller 614 is designed to receive from NDE system computer 614 certain type of information, e.g., amount of indexing required for a scan path (e.g., scan path 1816 of FIG. 18), manual controls input by a human interface to control robot 608 and new points or travel paths taught to 612. NDE system computer 614 may be thought of as an evaluation workstation, which is operated by a human interface.

In those instances where robot 608 does not receive scan plan information, e.g., angle of attack, stand-off distance, point of origin and boundary coordinates, integrating controller 614 integrates the type of information received from robot 608 with the scan plan information received from at least another type of robot (e.g., robot 620) to control movement of an underside robot (e.g., robot 644). However, in those instances where robot 608 receives scan plan information, then integrated controller 614 may not need to integrate information received from another type of robot (e.g., robot 620), and integrates the information received from robot 608.

Regardless of whether another type of robot is required for controlling movement of an underside robot, controller and client server 602 may provide, store and/or process information received from integrating controller 614. To this end, controller and client server 602 includes two file servers 624 and 634, a controller called “an image, spatial, on component controller” 626, a boolean logic dedicated processor 628, a database server 630 and disk storage 632. File server 624 may be communicatively coupled to one or more overhead NDE system computers (e.g., 612 and 618) to retrieve information from and provide information to overhead robot inspection system 604. Similarly, file server 634 may be communicatively coupled to one or more underside NDE system computers (e.g., 636) to retrieve information from and provide information to underside robot inspection system 606.

During an inspection process, underside NDE system computer 636 may receive information, from controller and client server 602, regarding underside robot's desired pinpoint destination on a component and/or a sub-component that is/are the subject of an inspection. From underside NDE system computer 636, this information may be conveyed to a controller 638 for a cart (e.g., cart 593 of FIG. 5E) having underside robot (e.g., robot 644) secured thereon and also to a controller 642 for the robot (e.g., robot 644) secured on the cart (e.g., cart 593 of FIG. 5E). Controller 638 and controller 642 may be different from each other as they serve different control functions. In one present arrangement, the two controllers 638 and 642 are communicatively coupled so that they are able to exchange information with each other to effectively control movement of underside robot 644 to the desired pinpoint destination for inspection.

Underside robot inspection system 606 includes an underside collision detection avoidance subsystem 640, which is communicatively coupled to controllers 638 and 642. Collision detection and avoidance subsystem 640 serves substantially the same function as overhead collision detection avoidance subsystem 616 except that underside collision detection avoidance subsystem 640 serves to avoid collision of underside robot 644 with other robots and/or component and/or sub-components of a craft undergoing inspection.

As shown in FIG. 6, inspection control system 600 includes provisions for controlling both overhead and underside robots during a craft inspection process. Controller and client server 602 of system 600, in accordance with one aspect of the present teachings, conveys information collected by an overhead robot (e.g., overhead robot 608 of FIG. 6 or overhead robot 330 of FIG. 3) to an underside robot (e.g., underside robot 644 of FIG. 6). As a result, there are numerous different types of inspection goals that may be accomplished by this conveyance from the overhead robot to the underside robot. In one embodiment of the present teachings, the overhead and the underside robots inspect a component and/or a sub-component of a craft in a corresponding manner. By way of example and as explained above in connection with overhead robot 330 and underside robot 340 of FIG. 3, either overhead robot 330 may provide the benefit of a source and underside robot 340 may provide the benefit of a receiver, or vice versa to obtain an image of the component and/or the sub-component during inspection.

As another example, Boolean rules stored on disk storage (e.g., disk storage 632 of FIG. 6) and processed by Boolean logic dedicated processor rules (e.g., Boolean logic dedicated processor rules 628 of FIG. 6) may facilitate inspection by the overhead robot and the underside robot in a corresponding manner. In this example, a Boolean rule may dictate the movement of the underside robot based on the type of information or defect detected by the overhead robot. Moreover, based on the inspection results of the overhead robot, Boolean rules may also dictate the type of NDI system deployed for underside inspection. An exemplar Boolean rule presented below illustrates an inspection scheme, in which both the overhead and the underside robot inspect in a corresponding manner.

If during the inspection of a craft's component, an overhead robot inspection detects severe moisture (as a defect) at a particular location on the component, then, for example, a Boolean logic rule may dictate a need for inspection of the same component using an underside NDI system suited for detecting a disbond or voids (as other likely defects found near severe moisture) along the component's underside boundaries proximate to that severe moisture location. To facilitate underside inspection, the overhead robot conveys the component's location information (e.g., boundary coordinates 1708, 1710 and 1712 of FIG. 17) to the underside robot. In addition to conveying the location information, overhead robot may also convey a reference point or information that would assist in developing (e.g., using controller and client server 602 of FIG. 6) an appropriate scan plan for the underside robot.

Based on the above example, the following exemplar Boolean algorithm may be stored on disk storage 632 and processed by Boolean logic dedicated processor rules 628 of FIG. 6:
If Component=1168, if Scan Plan=SP1, if Overhead NDI System=001248001, if defect=M, if defect severity=S, then 001248002, Scan Plan=SP2, Overhead Component Coordinates Based on Overhead NDI System Home Position=25.5, 16.7, 8.8, Facility Unit Component Coordinate Point of Origin=50.5, 18.8, 9.0, Facility Unit Component Coordinate Point 2=62.5, 20.8, 9.4, NDI System Cart=A, Parked Rail X1=5, Parked Rail X2=6, Indexing Positioner=Inspection Rail X3=7, Rail X4=8, Move Cart to Underside Component Coordinates Xc=50.5, Yc=18.8, Zc=9.0, and the scan plan SP2 is aligned on the underside candidate component based on the overhead candidate component Point of Origin and Point 2.

According to this algorithm, if during an inspection of a component panel bearing a panel number 1168 by a realtime X-ray NDI system bearing NDI system number 001248001 and implementing a scan plan, SP1, the component's point of origin is determined as 25.5, 16.7, 8.8 for X, Y, and Z locations, respectively, in a facility unit, and the overhead NDI system detects severe moisture, then the underside laser UT NDI system bearing NDI system number 001248002 is mobilized from Rails 5 and 6 using an index positioner to Rails 7 and 8 to implement a scan plan, SP2 at the facility unit location in space of Xc=50.5, Yc=18.8, and Zc=9.0 (as adjusted and transformed from the Overhead NDI System's component coordinates of X=25.5, Y=16.7, and Z=8.8). The laser UT scan plan, SP2, assigns a proper angle of attack and stand-off distance for effective underside inspection of the component from the component's point of origin.

Another exemplar Boolean algorithm stored on disk storage 632 and processed by Boolean logic dedicated processor rules 628 of FIG. 6 would be based on the rule that if an overhead NDI system (e.g., realtime X-ray and backscatter X-ray) detected a fuel leak during the inspection of a craft's component and/or sub-component, then an underside robot associated with a laser UT NDI system would be deployed to inspect the component for a disbond or voids along the component's underside boundaries proximate to the location of the fuel leak.

A yet another exemplar Boolean algorithm may be based on the rule that if an overhead NDI system (e.g., realtime X-ray and backscatter X-ray) detected impact damage (e.g., crack in the skin) during the inspection of a craft's component and/or sub-component, then an underside robot associated with a laser UT NDI system would be deployed to inspect the component for delamination along the component's underside boundaries proximate to the location of the crack.

A yet another exemplar Boolean algorithm may be based on the rule that if an overhead NDI system (e.g., realtime X-ray) detected stress corrosion cracks during the inspection of a craft's component and/or sub-component made from a metal substructure, then both underside and overhead inspections are conducted. In this example, a realtime X-ray source with its yoke articulated out of the way (e.g., overhead robot 330 of FIG. 3) would be used as the overhead robot and a DP X-ray receiver would be used as the underside robot. During inspection, the underside DP X-ray receiver locates the digital plate next to the location of defect at the component's underside to capture images with the overhead NDI system providing a benefit of an energized source. The overhead NDI system articulates around a tool point and preferably takes a minimum of eight images of the stress corrosion cracks as a volumetric measurement method, which allows identification of the length, width and depth of the cracks for engineering evaluation.

Regardless of the type of Boolean logic algorithm stored on disk storage 632 and processed by Boolean logic dedicated processor rules 628 of FIG. 6, the underside robot may rely on overhead NDI system's determination of the inspected component's boundary coordinates and/or an appropriate overhead scan plan (including a reference point) to effect the underside inspection.

The present teachings recognize that there may be more than one type of facility unit designed and built for inspecting crafts. One particular type of facility unit, referred to as a “reference facility unit,” is used for developing a reference database for a particular type and model of craft, which will be the subject of inspection. To develop a reference data base, certain details of a reference craft (which is deemed as the standard craft for that type and model of craft) are taught to a control and file server system (e.g., control and file server system 602 of FIG. 6) using machine vision. A reference database, among other things, records the location of a reference craft within the dimensions of reference facility unit.

A reference facility unit may be contrasted to a production facility unit, which is another type of facility unit. In a production facility unit, a candidate craft undergoes inspection for defect and repairs, if necessary. In a production facility unit, a candidate craft is located within the production facility unit using a reference database for a craft of a particular make, model or design. The present teachings recognize, however, that a production facility unit may not have the same dimensions as the reference facility unit.

FIG. 7A shows a commonly encountered misalignment 650 of two craft inspection facility units, i.e., a reference facility unit 652 and a production facility unit 654. In other words, there is an offset 656 between reference facility unit 652 and production facility unit 654. Moreover, in a production facility unit, information relating to dimensions or locations that account for offset 656 produces meaningful results.

In accordance with one aspect of the present teachings, facility unit offset 656 is a difference between a “reference plane” and a “candidate plane.” “Reference plane” is defined by a point of origin (for X, Y and Z-axes) of reference facility unit 653 and a home position of a particular type of overhead robot NDI system inside reference facility unit 653. “Candidate plane” is defined by a point of origin (for X, Y and Z-axes) of production facility unit 654 and a home position of the same type of overhead robot NDI system inside production facility unit 654.

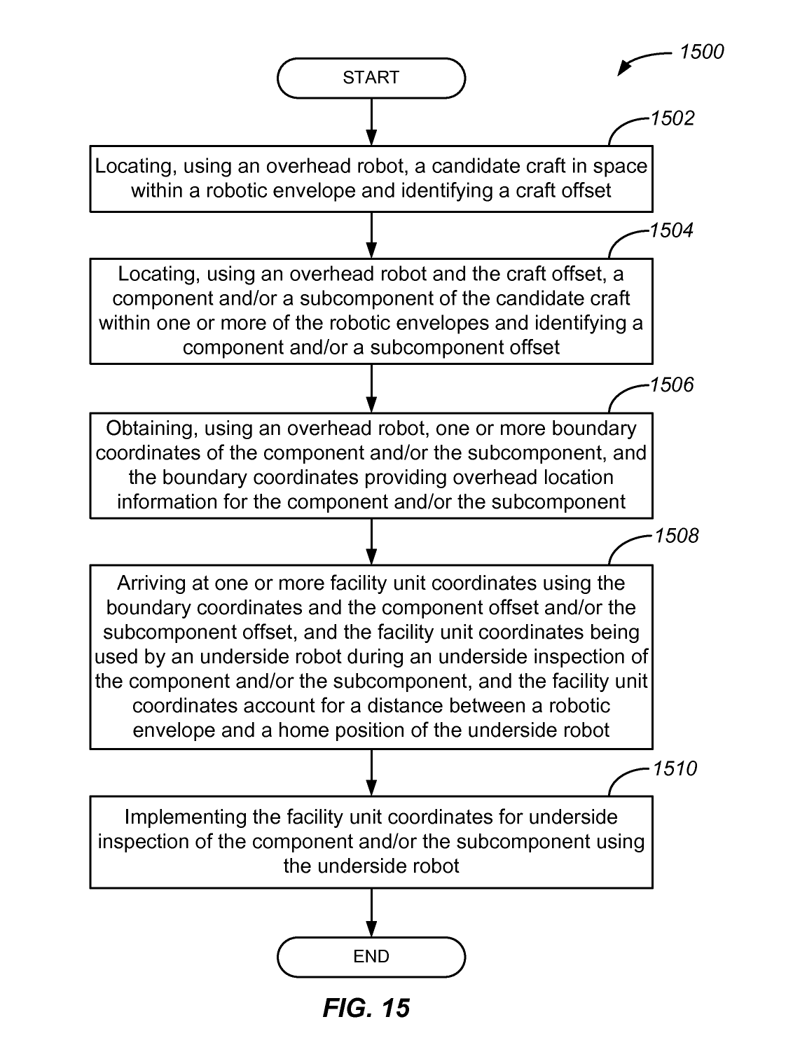

As will be explained below, knowledge of a facility offset value may be important in step 1502 of FIG. 15, which requires teaching location of a candidate craft in space within a robotic envelope to identify a craft offset. An inspection facility unit may have multiple robotic envelopes, which will be discussed in greater detail in connection with FIG. 8.

FIG. 7B shows, according to one embodiment of the present teachings, a top view of an inspection facility unit 700 that includes underside robots for inspection of a craft. FIG. 7B facilitates illustration of how one or more underside carts, each preferably having a robot associated with an NDI system secured thereon, are capable of mobilizing within a facility unit for underside inspection of a craft's component and/or sub-component.

According to the embodiment of FIG. 7B, facility unit 700 includes two home positions 704 and 718. One or more platforms 706 and 720 located at home position have one or more carts (e.g., cart 593 of FIG. 5E) secured thereon. During inspection, these carts are capable of mobilizing from home position 704 to indexing bed 712 through bed connection rails 710, or capable of mobilizing from home position 718 to an indexing bed 716 through bed rails disposed between them.

Regardless of which indexing bed is used, upon arrival of a cart on indexing bed 712, for example, it is secured upon an index positioner 708, which is capable of lateral movement (i.e., in the Y-direction) to align one or more index positioner rails (e.g., rails 1118 of FIG. 11) to one or more rails 714 on the floor surface of facility unit 700. Thus, in the configuration of FIG. 7B, carts are received at and/or launched from indexing bed 712. One or more rails 714 may be selected based on a scan plan and/or Boolean logic rules discussed above. One aspect of the present teachings recognizes that inspection impediments are avoided by appropriate selection of rails and use of an indexing bed. By way of example, if an engine of a craft obstructs an underside robot's travel path during inspection, a cart having secured thereon a particular NDI system robot may travel from indexing bed 712 down rails 714, which are outside the boundary of the craft's engine, to indexing bed 716. At indexing bed 716, the cart may be received onto an index positioner that mobilizes laterally, for example, by a bed drive subsystem, and selects one or more appropriate rails 714 that position the cart behind the craft's engine. From this position, the cart is launched to effectively inspect the area behind the engine. Thus, in one aspect, the teachings of the present invention allow the cart to effectively inspect a robotic envelope, which might be otherwise difficult to inspect due to the presence of impediments, by approaching it from a different direction.

The present teachings recognize that a robotic envelope is a three-dimensional inspection sector within a facility unit and that there might be many different types of robotic envelopes. A facility unit may have a separate robotic envelope for left wing, right wing, left stabilizer, right stabilizer, fuselage and vertical stabilizer. Moreover, in a production facility unit, the dimensions of each robotic envelope may be adjusted for a facility offset (e.g., facility offset 656 of FIG. 7A). In some embodiments of the present arrangement, one or more robots, each associated with a unique NDI method, are used exclusively in one robotic envelope. Another set of robots associated with a different NDI method may inspect inside another robotic envelope. As a result, one aspect of the present teachings allows multiple robots to inspect different robotic envelopes within a facility unit simultaneously, reducing overall inspection time. Another aspect of the present teachings allows multiple robots to inspect different robotic envelopes within a similar facility unit of different dimensions simultaneously, reducing overall inspection time.

FIG. 8 shows a portion of a craft inspection facility 800 that includes home positions 804 and 818, platforms 806 and 820, indexing beds 812 and 816, index positioners 808 and rails 814, which are substantially similar to their counterparts in FIG. 7, i.e., home positions 704 and 718, platforms 706 and 720, indexing beds 712 and 716, index positioners 708 and rails 714. FIG. 8 shows a robotic envelope for a wing 822, and FIG. 7 shows a robotic envelope for, among other things, an airplane 702.

In FIG. 8, different inspection sections, within robotic envelope of wing 822, are numerically labeled 1 through 5 to facilitate discussion. During inspection of wing 822, the cart may approach the robotic envelope of wing 822 from the rear to inspect areas “1,” “3” and “4,” and may similarly approach the same robotic envelope from the front to inspects area “1” and “2,” though it may be impossible for the cart to arrive near section “5” due to the presence of the engine or some other impediment (e.g., landing gear). In this situation, software limits (e.g., in collision detection avoidance subsystem 640 of FIG. 6) creates an exclusionary zone that prevents the underside robot from mobilizing to and colliding with that section (e.g., wing 822's section “5”) of the component and/or the sub-component.

Exclusionary zones are NDI-system specific, and instructions relating to them are stored accordingly. By way of example, a robot associated with realtime X-ray might be instructed to not encroach the limits from a particular exclusionary zone, but a laser UT may be allowed into that exclusionary zone.

FIG. 9 shows a portion of an inspection facility 900, inside which index positioners 908 are capable of lateral movement when positioned on an indexing bed 904. By virtue of this later movement, one or more of index positioner rails (e.g., index positioner rails 1118 of FIG. 11) align with one or more of rails 914 on the facility unit's floor surface. Furthermore, as explained in the embodiment of FIG. 5A, lateral movement of index positioner may be enabled by a bed drive subsystem.

FIG. 10 shows a subassembly 1000 of an index positioner 1008 that is secured inside a channel 1012 that is defined inside an exemplar indexing bed 1010 (which is substantially similar to indexing bed 540 of FIG. 5A). Although channel 1012 is disposed below the floor level of a facility unit and deep enough to accommodate a bearing surface 1014 and house at location 1016, a provision to couple with a drive subassembly and allow for movement of the overlying index positioner 1008, certain aspects of the present teaching contemplate using drive subassembly that is not subterranean and/or not using bearing surfaces at all.

FIG. 11 shows an index positioner 1108, in accordance with a preferred embodiment of the present arrangement, that rides on a bearing surface 1114 using a bed drive subsystem coupled to a threaded shaft 1116 and mobilizes in a first direction (e.g., Y-direction). In this preferred arrangement, one or more index positioner rails 1118, capable of receiving and launching a cart (which has an NDI system robot secured thereon), extend perpendicular to the first direction. FIG. 5E shows in greater detail cart 593 having wheels 599. Cart 593 includes a lower carriage 1232 that moves along a lower beam 1234 of FIG. 12. In certain embodiments of the present teachings, lower beam is thought to be functionally akin to beam 114 of FIG. 1 as it facilitates movement of lower carriage 1232, which may be thought to be functionally similar to overhead carriage 116. Overhead carriage 116 has secured thereon an overhead robot, and lower carriage 1232 has secured thereon an underside robot. By way of example, during an imaging operation that involves both overhead and underside robots, overhead carriage 116 and lower carriage 1232 move in a coordinated fashion.

The present teachings provide various processes for developing a reference database and conducting craft inspections. The systems, subsystems and structural details provided herein, however, are not necessary to carry out the processes of the present teachings. Furthermore, to the extent reference is made to those systems, subsystems or structural details, such references should be construed as offering exemplar embodiments to facilitate discussion.

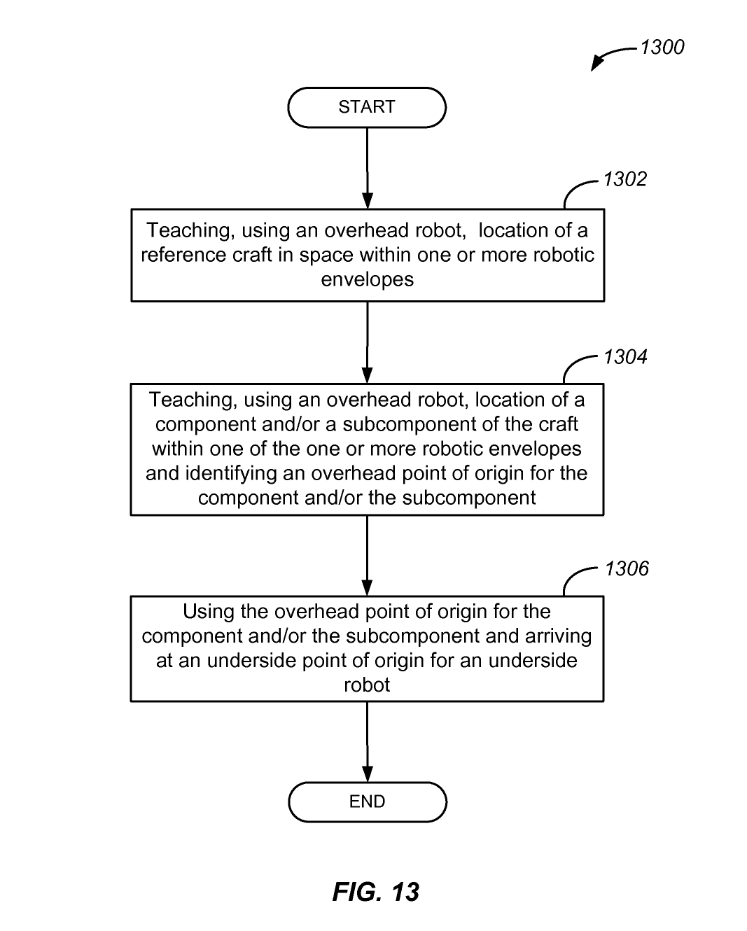

FIG. 13 shows a process 1300, in accordance with one embodiment of the present teachings, for developing a reference database. Process 1300 begins with a step 1302 that involves teaching, using an overhead robot, location of a reference craft in space within one or more robotic envelopes. By way of example, the reference craft is a craft of a particular model and series. Step 1302 also includes positioning and securing the reference craft within one or more robotic envelopes. If a reference craft is an aircraft, then a nose gear or main landing gear tire is aligned to a centerline and a line on a floor of one or more robotic envelopes. In this example, the reference aircraft is then immobilized and can be jacked to take load off tires or actuators or tires and actuators can be loaded. Thus, the aircraft becomes fixed in position and can no longer move due to changes in tire pressure attributed to environmental changes or changes of hydraulic pressure in the actuators.

Continuing with step 1302, an overhead robot associated with an NDI method may then be taught, using machine vision, at least two reference coordinates defining a boundary of reference craft such that during subsequent inspection of candidates crafts, each candidate craft is automatically located in space using overhead robot. For example, on an aircraft, at least two reference coordinates defining a boundary of reference aircraft are chosen from more than one component and/or sub-component. Examples of features that define the reference aircraft's boundary include an edge of a wing, an edge of a vertical stabilizer, a location on the nose and a location and/or edge of a fuselage. Overhead robot is taught a reference coordinate by, for example, placing machine vision crosshairs on an outer corner or edge of a component and/or a sub-component. Machine vision records the chosen reference coordinate. Using two or more reference coordinates, the reference database learns the location of craft in space within one or more robotic envelopes.

As mentioned above, a reference craft need not be limited to an aircraft. Reference craft may be chosen from a group comprising an aircraft, an airplane, a boat, a submarine, a bicycle, a car, a truck, a bus, a motorcycle, a train, a ship, a watercraft, a sailcraft, a hovercraft and a spacecraft.

Next, step 1304 includes teaching, using an overhead robot, the location of a component and/or sub-component of a craft within one of the one or more robotic envelopes and identifying an overhead point of origin for the component and/or sub-component. In this step, an overhead robot is preferably initially taught the location of a component and/or sub-component within one or more robotic envelopes. According to one embodiment of the present teachings, the overhead robot, using machine vision, is taught at least two edges defining a boundary of the component and/or the sub-component. Using at least two edges defining a boundary of the component and/or the sub-component, the reference database is capable of determining a location of the component and/or the sub-component such that during subsequent inspection of candidate component and/or sub-component, each candidate component and/or sub-component is automatically located in space using overhead robot.

After location of the component and/or the sub-component of reference craft is taught, then step 1304 includes identifying an overhead robot point of origin for the component and/or the sub-component. Point of origin is a vertex, where two or more boundary edges of the component and/or the sub-component intersect. Point of origin establishes a “zero, zero” coordinate in the X, Y and Z-axis plane for the component and/or the sub-component.

To this end, FIG. 16 shows an exemplar map 1600 for a right leading edge box of right horizontal stabilator. For the horizontal stabilator, map 1600 shows forward coordinates plotted along a Y-axis, denoted by a reference numeral 1604, versus inboard coordinates plotted along X-axis, denoted by reference numeral 1602. A point of origin for the horizontal stabilator is denoted by reference numeral 1608 on map 1600. By way of example, point of origin 1608 for the horizontal stabilator is determined at a vertex of the bottom boundary edge and the right boundary edge. This information may then be stored in a reference database for this particular craft.

The present invention recognizes that identifying the overhead point of origin for the component and/or the sub-component may not necessarily be conducted as part of step 1304, and may be conducted in a separate step that is different from step 1304.

Next, a step 1306 includes using the overhead point of origin for the component and/or the sub-component and arriving at an underside point of origin for an underside robot. By way of example, the overhead point of origin for the component and/or the sub-component may be conveyed to controllers and client servers (e.g. controller and client server 602 of FIG. 6), which may compute the underside point of origin that is used by the underside robot during inspection of the component and/or the sub-component.

The present invention recognizes that neither identifying an overhead point of origin for a particular component and/or sub-component, nor step 1306 is necessary, but performing them during development of a reference database represents one preferred implementation of the present teachings.

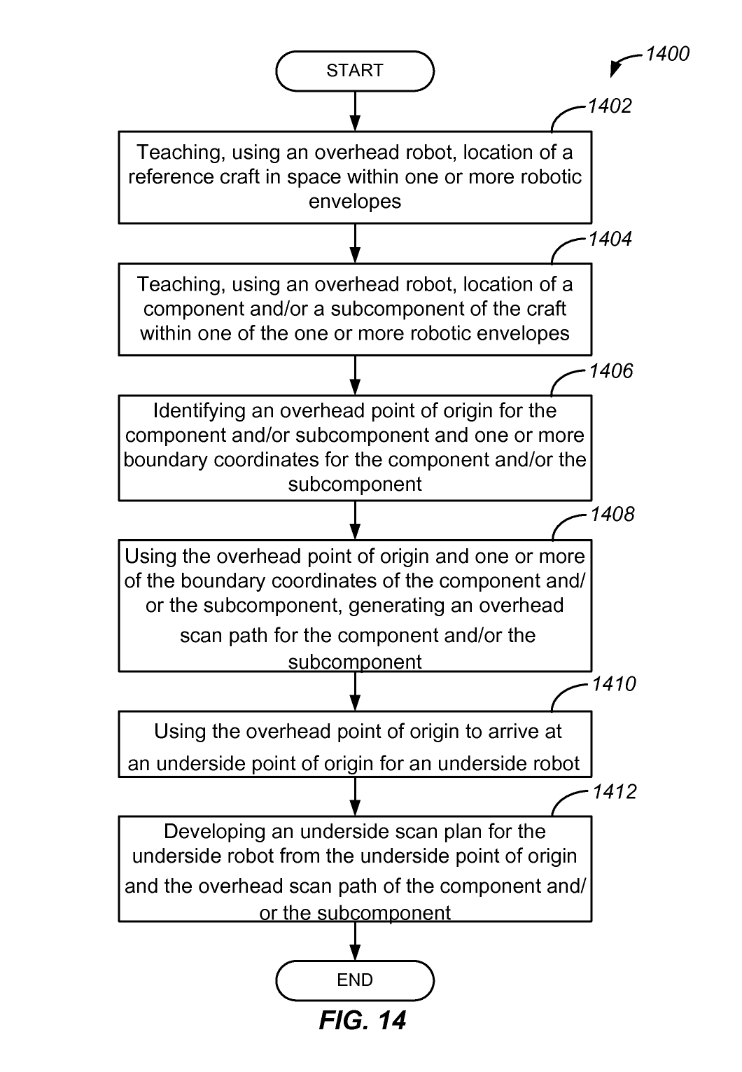

FIG. 14 shows another process 1400, according to an alternate embodiment of the present teachings, for developing a reference database. Process 1400 includes steps 1402 and 1404, which are substantially similar to steps 1302 and 1304 of process 1300 of FIG. 13. Next, a step 1406 includes identifying an overhead point of origin for the component and/or the sub-component and one or more boundary coordinates for the component and/or the sub-component.

Identifying the overhead point of origin for the component and/or the sub-component may be carried out in substantially the same manner as described in the discussion relating to step 1304 of FIG. 13. To identify one or more boundary coordinates for the component and/or the sub-component, machine vision crosshairs may be placed on outer corners of the component and/or the sub-component. Machine vision then records the chosen boundary coordinates.

By way of example, FIG. 17 shows an exemplar map 1700 for a right leading edge box of right horizontal stabilator with boundary coordinates. Map 1700 includes a Y-axis and X-axis denoted by reference numerals 1704 and 1702, respectively. These axes are substantially similar to the axes denoted by reference numerals 1604 and 1602 of FIG. 16. Map 1700 also includes an overhead point of origin 1708, which is substantially similar to point of origin 1608 of FIG. 16. Furthermore, map 1700 shows boundary coordinates 1710, 1712 and 1714. In particular, boundary coordinates 1712 and 1714 define a boundary or an edge 1706 of the horizontal stabilator. These boundary coordinates are preferably stored in a computer system, e.g., controller and client server 602 of FIG. 6.

Referring back to FIG. 14, process 1400 then includes a step 1408, which includes using the overhead point of origin and one or more boundary coordinates of the component and/or the sub-component and generating an overhead scan path for the component and/or the sub-component.

The present invention recognizes that scan path in this step is taught for each NDI system that is subsequently implemented to detect defects in candidate airplanes. Scan paths are different for each robotic imaging method such as for N-ray, X-ray or laser UT, because of the field of view and the area of interest due to the type of airplane structure. Nonetheless, the point of origin and one or more boundary coordinates for each component and/or sub-component remain the same.

A scan path starts at component point of origin and covers any part or section of the component and/or the sub-component within the boundary coordinates of the component and/or the sub-component. FIG. 18 shows a map 1800 for a right leading edge box of right horizontal stabilator with boundary coordinates. Map 1800 includes a Y-axis and X-axis denoted by reference numerals 1804 and 1802, respectively. These axes are substantially similar to the axes denoted by reference numerals 1704 and 1702 of FIG. 17. Map 1800 also includes an overhead point of origin 1808, which is substantially similar to point of origin 1608 of FIG. 16, and boundary coordinates 1810, 1812 and 1814, which are substantially similar to boundary coordinates 1710, 1712 and 1714 of FIG. 17. In map 1800, a boundary or an edge 1806 is substantially similar to boundary 1706 shown in FIG. 17. Based on these overhead points of origin and boundary coordinates for the component and/or the sub-component, a computer system, such as controller and client server 602 of FIG. 6, is programmed to automatically generate a scan path. In map 1800, a scan path so developed for the horizontal stabilator is denoted by reference numeral 1816.

In process 1400, step 1410 is then carried out. Step 1410 includes using the overhead point of origin for the component and/or the sub-component to arrive at an underside point of origin (for the component and/or the sub-component) for an underside robot. This step is substantially similar to step 1306 of FIG. 13.

Next, step 1412 involves developing an underside scan path for the underside robot from the underside point of origin and the overhead scan path of the component and/or the sub-component. Based on the underside point of origin and the overhead scan path of the component and/or the sub-component, a computer system, such as controller and client server 602 of FIG. 6, is programmed to automatically generate a scan path implemented by an underside robot during inspection.

The present invention recognizes that to generate a scan path implemented by an underside robot during inspection, it is not necessary to use the overhead scan path. Rather, a scan path for the underside robot may be generated using the overhead point of origin and boundary coordinates for the component and/or the sub-component. In other words, it is possible to program a computer system, such as controller and client server 602 of FIG. 6, to automatically generate a scan path for the underside robot using the overhead point of origin and boundary coordinates for the component and/or the sub-component.

FIG. 15 shows a process 1500, according to one embodiment of the present teachings, for inspecting a component and/or sub-component for defects. Process 1500 preferably begins with a step 1502, which includes locating, using an overhead robot, a candidate craft in space within one or more robotic envelopes and identifying a craft offset.

As explained in connection with FIG. 7A, locating the candidate craft within a robotic envelope preferably includes accounting for a facility offset. As previously discussed, facility offset adjusts for dimensional differences between a reference facility unit and a production facility unit. After an overhead robot determines the facility offset, it is likely to more accurately locate a candidate craft in space within a robotic envelope.

Overhead robot locates a candidate craft in space within a robotic envelope by preferably taking certain craft positioning and immobilizing measures that are similar to those taken when attempting to locate a reference craft in space. Then, an overhead robot may maneuver machine vision to a major candidate craft edge boundary. In the case of an aircraft inspection, a craft edge or boundary may include one chosen from a group comprising an edge of a wing, an edge of a vertical stabilizer, a location on the nose and a location and/or edge of a fuselage. The overhead robot, using machine vision, identifies at least two edges defining an edge boundary of the candidate craft and determines where edges intersect. A boundary edge of candidate craft is the intersection or vector of two boundaries defined by spatial coordinates (along X, Y and Z-axes). Using the boundary-edge spatial coordinates of candidate craft and reference database, the overhead robot is capable of locating a craft is in space within one or more robotic envelopes.

As mentioned in connection with step 1502, the overhead robot identifies a craft offset. Craft offset is the difference in location between reference craft and candidate craft in space. To determine craft offset, overhead robot compares spatial coordinates of boundary edge of candidate craft with spatial coordinates of the same boundary edge of reference craft. The difference between the two spatial coordinates is the craft offset. Craft offset may be expressed in terms of spatial coordinates (i.e., along X, Y and Z-axes). Using facility offset and reference database for craft, allows the overhead robot to locate a craft in space and identify a craft offset.

Step 1504 includes locating, using overhead robot and craft offset, a component and/or sub-component of candidate craft within one or more robotic envelopes and identifying a component offset and/or a sub-component offset. Overhead robot may determine the general location of any component and/or sub-component using the craft offset and the craft reference database. A reference database has stored thereon location information of all reference components and/or sub-components. To locate a candidate component and/or sub-component, the overhead robot may apply craft offset to reference location of component and/or sub-component. To inspect at that location, the overhead robot may move to that location.

The overhead robot, using machine vision, arrives at location of a component and/or sub-component. At this state, machine vision cross hairs align with a boundary edge of a component and/or sub-component. However, certain candidate components and/or sub-components may have slightly moved causing machine vision cross hairs not to align with the boundary edge. Misalignment may be due to candidate component and or sub-component movement while craft was in an operational state. Some candidate components and/or sub-components move using, for example, actuators, gear and pistons. These candidate components and/or sub-component will likely not return to the same position as a reference component and/or sub-component.

As a result, the overhead robot is preferably taught a new location of the candidate component and/or sub-component. To teach new location of candidate component and or sub-component, machine vision cross hairs are manually aligned with boundary edge of candidate component and/or sub-component. The overhead robot, using machine vision, now learns the true location of the candidate component and/or sub-component in space and can determine a component offset and/or a sub-component offset.

A component and/or a sub-component offset is a difference in location between reference component and/or sub-component and candidate component and/or sub-component in space. To determine craft offset, overhead robot may compare spatial coordinates of boundary edge of candidate component and/or sub-component with spatial coordinates of the same boundary edge of reference component and/or sub-component. The difference between the two spatial coordinates is component and/or sub-component offset. As mentioned above, the craft offset may be represented in spatial coordinates (i.e., along X, Y and Z-axes). Using the craft offset and a reference database for craft, the overhead robot is able to locate component and/or sub-component in space and identify a component and/or sub-component offset.

Step 1506 includes obtaining, using overhead robot, one or more boundary coordinates of component and/or sub-component, and boundary coordinates provide overhead location information for component and/or said sub-component. To obtain candidate component and/or sub-component boundary coordinates, overhead robot uses component and/or sub-component offsets and the craft reference database. Reference component and/or sub-component boundary coordinates are stored on the craft reference database. The overhead robot applies component and/or sub-component offsets to the reference component and/or sub-component boundary coordinates. During inspection, the overhead robot may determine candidate component and/or sub-component boundary coordinates.

The candidate component and/or sub-component boundary coordinates may be stored in any computer system, e.g., controller and client server 602 of FIG. 6. Candidate component and/or sub-component boundary coordinates may be used by any other overhead robot associated with an NDI method or by underside robots.

Step 1508 includes arriving at one or more facility unit coordinates using component and/or sub-component boundary coordinates and component offset and/or sub-component offset. The facility unit coordinates are preferably used by an underside robot during an underside inspection of component and/or said sub-component. The facility unit coordinates account for a distance between robotic envelope as adjusted for facility unit offset and a home position of the underside robot.

The candidate component and/or sub-component boundary coordinates, which already include component and/or sub-component offset, are stored as described above. The candidate component and/or sub-component boundary coordinates may be translated to facility unit coordinates using a computer system, such as controller and client server 602 of FIG. 6. Facility offset, craft offset, robotic envelope and component and/or sub-component offset are preferably calculated into the facility coordinates.

Step 1510 includes implementing the facility unit coordinates for underside inspection of the component and/or the sub-component using the underside robot. Using facility coordinates, the underside robot is automatically able to inspect the component and/or sub-component at issue.

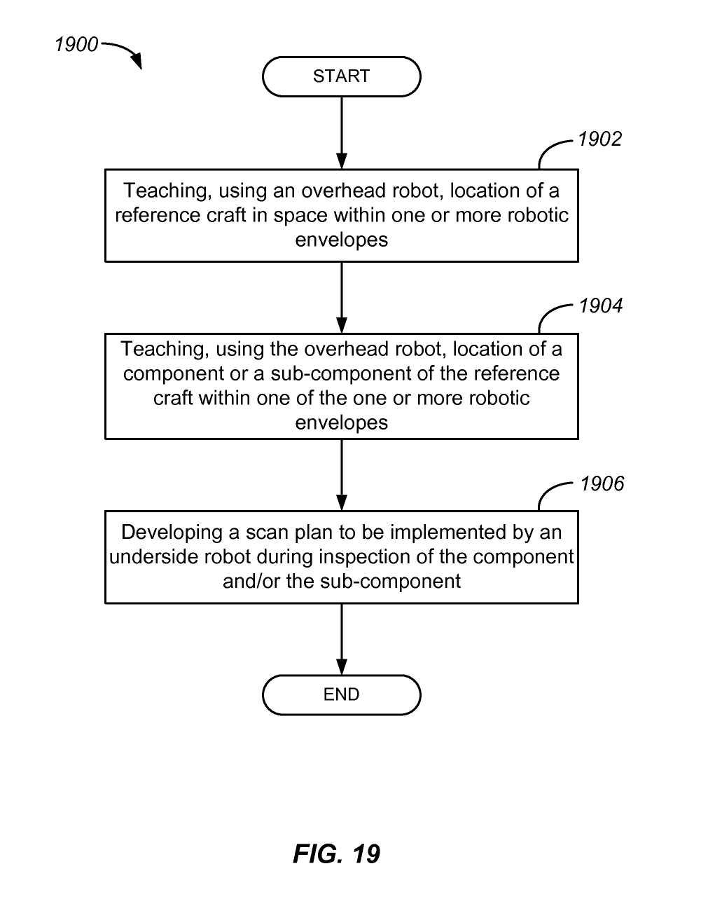

FIG. 19 shows a process 1900, in accordance with one preferred embodiment of the present teachings, for developing a reference body database. Process 1900 includes steps 1902 and 1904, which are substantially similar to steps 1302 and 1304 of FIG. 13. Next, however, a step 1906 is performed. This step includes developing a scan path to be implemented by an underside robot during inspection of component and/or sub-component. Developing a scan path includes teaching the underside robot a travel path between a reference point of location to a component point of location and/or a sub-component point of location. In one embodiment of the present teachings, the reference point of location is a location on reference craft and the component point of location and/or sub-component point of location is a location on the component and/or the sub-component.

According to FIG. 19, once the overhead robot locates the craft in space and locates the component and/or sub-component in space, no information (location or otherwise) is conveyed to a computer system, which calculates coordinates for the underside robot. Rather, process 1900 of FIG. 19 contemplates processes, according to which after steps 1902 and 1904 have concluded, the underside robot, independent of the overhead robot, determines its own point of origin and/or boundary coordinates for a component and/or a sub-component and determines its own scan path.

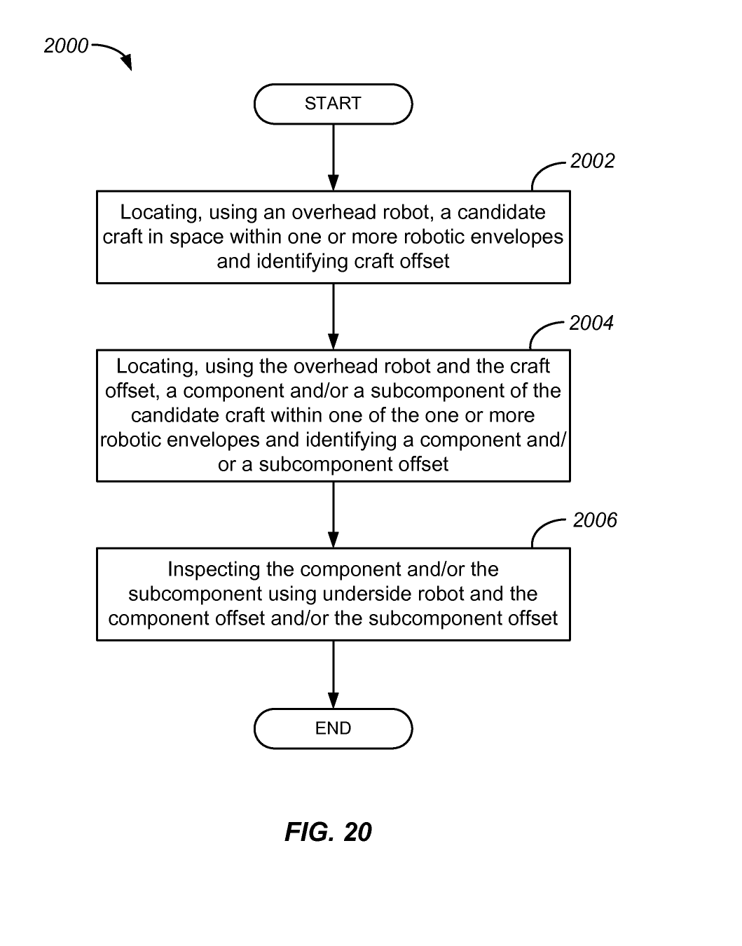

FIG. 20 shows a process 2000, according to one embodiment of the present teachings, for inspecting a craft. Process 2000 includes steps 2002 and 2004, which are substantially similar to steps 1502 and 1504 of FIG. 15. In a preferred implementation of process 2000, after steps 2002 and 2004 have concluded, a step 2006 includes inspecting the component and/or the sub-component. The inspection of step 2006 is carried out using the underside robot and by accounting for the component offset and/or the sub-component offset.

The underside robot may be instructed to travel a travel path between a reference point of location to a component point of location and/or a sub-component point of location. As mentioned above, the reference point of location is a location on the reference craft, and the component point of location and/or the sub-component point of location are a location on the component and/or the sub-component, respectively. The inspection process 2000 contemplates inspection by an underside robot that is independent of an overhead robot's inspection of a component and/or a sub-component. In other words, after steps 2002 and 2004 have concluded, the underside robot inspects independent of the location information of an overhead robot that assists in location of craft and a component and/or sub-component in space.

In one preferred implementation of the present teachings, at the component point of location and/or the sub-component point of location, the underside robot is instructed to implement a predetermined scan path. A predetermined scan path may be, but need not necessarily be, based on a scan path associated with overhead robot and/or boundary coordinates obtained from an overhead robot.

In other alternate embodiments of the present teachings, after steps 2002 and 2004 have concluded, a craft inspection process further includes conveying from the overhead robot to an underside robot at least one information chosen from a group comprising a point of origin of component and/or sub-component, one or more boundary coordinates of component and/or sub-component, overhead scan plan, signal to commence underside inspection, component offset and sub-component offset.

What is claimed is:

1. A craft inspection process comprising:
locating, using an overhead robot, a candidate craft in space within one or more robotic envelopes and identifying craft offset;
locating, using said overhead robot and said craft offset, a component and/or sub-component of said candidate craft within one of said one or more robotic envelopes and identifying a component offset and/or sub-component offset;
conveying from said overhead robot to one or more computer systems at least one information chosen from a group including a point of origin of said component and/or said sub-component, one or more boundary coordinates of said component and/or said sub-component, an overhead scan path, signal to commence underside inspection, component offset and sub-component offset; and
processing, using said one or more computer systems, said at least one information received from said overhead robot to develop underside information used during underside inspection.

2. The craft inspection process of claim 1, further comprising conveying said underside information from said one or more computer systems to an underside robot.

3. A process for developing a reference database, said process comprising:
teaching, using an overhead robot, location of a reference craft in space within one or more robotic envelopes;
teaching, using said overhead robot, location of a component and/or a sub-component of said craft within one of said one or more robotic envelopes;
identifying an overhead point of origin for said component and/or said sub-component; and
using said overhead point of origin for said component and/or said sub-component and arriving at an underside point of origin for an underside robot.

4. The process for developing a reference database of claim 3, wherein said reference craft is a craft chosen from a group comprising an aircraft, an airplane, a boat, a submarine, a bicycle, a car, a truck, a bus, a motorcycle, a train, a ship, a watercraft, a sailcraft, a hovercraft and a spacecraft.

5. The process for developing a reference database claim 3, wherein said teaching location of said referenced craft in space includes:
aligning a nose gear or a main landing gear tire to a center line and a line on a floor of one of said one or more robotic envelopes, respectively;
immobilizing said reference craft;
taking load off tires or actuators or loading tires and actuators of said reference craft; and
teaching said overhead robot, using machine vision, at least one reference coordinate defining a boundary of said reference craft.

6. The process for developing a reference database of claim 5, wherein said at least two edges defining said boundary of said reference craft include any two features chosen from a group comprising an edge of a wing, an edge of a vertical stabilizer, an edge of a horizontal stabilizer, a location on the nose, and a location and/or edge of a fuselage.

7. The process for developing a reference database of claim 3, wherein said teaching location of said component and/or said sub-component includes teaching said overhead robot, using machine vision, one or more reference coordinates defining a boundary of said component and/or said sub-component in reference to said facility unit.

8. The process for developing a reference database of claim 3, wherein said using includes conveying said point of origin of said component and/or sub-component from said overhead robot to said underside robot through one or more computer systems.

9. The process for developing a reference database of claim 8, where in said conveying includes:
conveying said point of origin from said overhead robot to an overhead robot system computer;
conveying said point of origin from said overhead robot system computer to one or more computer systems;
conveying said point of origin from said one or more computer systems to an underside robot system computer; and
conveying said point of origin from said underside robot system computer to said underside robot.

10. A process for developing a reference database, said process comprising:
teaching, using an overhead robot, location of a reference craft in space within one or more robotic envelopes within a facility unit;
teaching, using said overhead robot, location of a component and/or a sub-component of said craft within one of said one or more robotic envelopes;
identifying an overhead point of origin for said component and/or said sub-component and one or more boundary coordinates for said component and/or said sub-component;
using said overhead point of origin and one or more of said boundary coordinates of said component and/or said sub-components, generating an overhead scan path for said component and/or said sub-component;
arriving at an underside point of origin for an underside robot using said overhead point of origin; and
developing an underside scan path for said underside robot from said underside point of origin and said overhead scan path of said component and/or said sub-component or from said underside point of origin and said boundary coordinates of said component and/or said sub-component.

11. A craft inspection process comprising:
locating, using an overhead robot, a candidate craft in space within one or more robotic envelopes and identifying a craft offset;
locating, using said overhead robot and said craft offset, a component and/or sub-component of said candidate craft within one or more robotic envelopes and identifying a component offset and/or a sub-component offset;
obtaining, using said overhead robot, one or more boundary coordinates of said component and/or said sub-component, and said boundary coordinates providing overhead location information for said component and/or said sub-component;
arriving at one or more facility unit coordinates using said boundary coordinates and said component offset and/or said sub-component offset, and said facility unit coordinates being used by an underside robot during an underside inspection of said component and/or said sub-component, and said facility unit coordinates account for a distance between said robotic envelope and a home position of the underside robot; and
implementing said facility unit coordinates for underside inspection of said component and/or said sub-component using said underside robot.

12. The craft inspection process of claim 11, wherein said boundary coordinates are stored in any at least one of one or more computer systems, an overhead robot system computer and an underside robot system computer.

13. The craft inspection process of claim 11, further comprising arriving at a facility unit offset, which is a difference between a reference plane and a candidate plane, and said reference plane being defined by a point of origin of a production facility unit and a home position of an overhead robot inside said production facility unit, and said candidate plane being defined by a point of origin of a reference facility unit and a home position of said overhead robot inside said reference facility unit, and wherein said candidate craft undergoes inspection inside said production facility unit and said a reference craft is taught inspection parameters inside said reference facility unit.

14. The craft inspection process of claim 13, wherein said locating said candidate craft in space includes using said facility unit offset.

15. A process for developing a reference database, said process comprising:
teaching, using an overhead robot, location of a reference craft in space within one or more robotic envelopes;
teaching, using said overhead robot, location of a component and/or sub-component of said reference craft within said one of said one or more robotic envelopes; and
developing a scan path to be implemented by an underside robot during inspection of said component and/or said sub-component.

16. The process of developing a reference database of claim 15, wherein said developing a scan path includes teaching said underside robot a travel path between a reference point of location to a component point of location and/or a sub-component point of location, and wherein said reference point of location being located on said reference craft and said component point of location and/or said sub-component point of location being located on said component and/or said sub-component of said reference craft.

17. The process of developing a reference database of claim 15, further comprising developing a scan path for an overhead robot that operates in a corresponding manner to said underside robot during inspection of said component and/or said sub-component.

18. A craft inspection process comprising:
locating, using an overhead robot, a candidate craft in space within one or more robotic envelopes and identifying craft offset;
locating, using said overhead robot and said craft offset, a component and/or sub-component of said candidate craft within one of said one or more robotic envelopes and identifying a component offset and/or sub-component offset; and
inspecting said component and/or said sub-component using an underside robot and said component offset and/or said sub-component offset.

19. The craft inspection process of claim 18, further comprising:
conveying from said overhead robot to one or more computer systems at least one information chosen from a group including a point of origin of said component and/or said sub-component, one or more boundary coordinates of said component and/or said sub-component, an overhead scan path, signal to commence underside inspection, component offset and sub-component offset; and
processing, using said one or more computer systems, said at least one information received from said overhead robot to develop underside information used during underside inspection.

20. The craft inspection process of claim 18, wherein said inspecting includes:
instructing said underside robot to travel a travel path between a reference point of location to a component point of location and/or a sub-component point of location, and wherein said reference point of location being located on said reference craft and said component point of location and/or said sub-component point of location being located on said component and/or said sub-component; and
instructing said underside robot to implement a predetermined scan path.

21. The craft inspection of claim 20, wherein said predetermined scan path is based on a scan path associated with said overhead robot and/or boundary coordinates obtained from said overhead robots.

22. A craft inspection facility unit comprising:
a robot associated with a non-destructive inspection (“NDI”) system and capable of inspecting an underside of a craft;
one or more rails extending along a dimension and disposed on a floor surface of the inspection facility unit;
a rail drive subsystem proximate said one or more rails and capable of mobilizing said robot on said one or more rails; and
wherein during an operational state of said robot, said rail drive subsystem mobilizes said robot to a predetermined location on the rail.

23. The craft inspection facility unit of claim 22, wherein said NDI system is at least one inspection system chosen from a group comprising x-ray, ultrasonics, thermography, holography, shearography and neutron radiography.

24. The craft inspection facility unit of claim 22, wherein said rail drive subsystem includes one member chosen from a group comprising a motor, a rack and pinion drive mechanism, an encoder and a resolver.

25. The craft inspection facility unit of claim 22, wherein said rail drive subsystem mobilizes said robot according to a predetermined scan path associated with said NDI system and with a component or a sub-component of said craft.

26. A craft inspection facility unit comprising:
a robot associated with a non-destructive inspection (“NDI”) system and capable of inspecting an underside of a craft;
one or more rails extending along a dimension of the inspection facility unit; and
wherein each of said one or more rails capable of supporting thereon said robot, and during an operational state of said robot, said robot functions as an image receiver for an overhead robot functioning as an energy source that is disposed above said craft or said robot functions as said energy source for said overhead robot functioning as said image receiver that is disposed above said craft.

27. The inspection facility unit of claim 26, wherein said NDI system is a real-time x-ray system.

28. The inspection facility unit of claim 26, wherein during an operational state of said robot, said robot receives signals generated from said imaging source.

29. The inspection facility unit of claim 26, wherein said one or more rails are disposed on a floor surface of said inspection facility unit.

30. The inspection facility unit of claim 26, wherein said robot has an underside scan path implemented during inspection of a component and/or a sub-component of said craft and said overhead robot has an overhead scan path implemented during inspection of said component and/or said sub-component, and wherein said underside scan path corresponds to said overhead scan path such that an image of at least a portion of said component and/or said sub-component is obtained during inspection.

31. An underside craft inspection system comprising:
one or more rails capable of supporting a robot associated with a non-destructive inspection (“NDI”) system;
one or more beds proximate said one or more rails and capable of supporting said robot;
one or more bed drive subsystems proximate said one or more beds and capable of mobilizing said robot on said one or more beds to a predetermined location on said one or more beds; and
wherein during an operational state of said robot, said one or more bed drive subsystems mobilizes said robot to a predetermined location on said one or more beds and allowing selection of one or more rails for inspection of a component and/or sub-component of said craft.

32. The underside craft inspection system of claim 31, wherein one or more of said bed drive subsystems is one member chosen from a group comprising a motor-driven ball screw, a rack and pinion drive system and a motor-driven cable system.

33. The underside craft inspection system of claim 31, wherein said one or more bed drive subsystems includes at least one component chosen from a group comprising a motor, an encoder, and a resolver.

34. The underside craft inspection system of claim 31, wherein one or more of said bed drive subsystems extend along a dimension of robotic envelope, inside which said craft undergoes inspection.

35. The underside craft inspection system of claim 31, wherein one or more of said bed drive subsystems is capable of having mobilized thereon multiple index positioners one at a time or simultaneously.

36. The underside craft inspection system of claim 35, further comprising a controller for mobilizing at least one of said index positioners on said one or more beds.

37. The underside craft inspection system of claim 31, further comprising an index positioner capable of supporting thereon one or more underside robots, at least some of which are associated with an NDI system, and one or more of said bed rails mobilize said index positioner along said one or more beds and facilitate selection of one or more of said rails.

38. The underside craft inspection system of claim 37, wherein one or more of said beds comprise a bearing surface upon which said index positioner is positioned during mobilization of said index positioner.

39. The underside craft inspection system of claim 38, wherein said bearing surface facilitates continuous mobilization of said index positioner inside one of said one or more beds.

40. The underside craft inspection system of claim 38, wherein said bearing surface includes linear roller bearings.

41. The underside craft inspection system of claim 38, wherein said bearing surface is secured to a bottom or a side of each of said one or more beds.

42. The underside craft inspection system of claim 38, wherein said bearing surface prevents side-to-side movements of said index positioner, said side-to-side movements being movements in a direction that is perpendicular to a mobilization direction of said index positioner.

43. The underside craft inspection system of claim 35, wherein each of said one or more beds have space defined therein to house multiple said bed drive subsystems to mobilize said multiple index positioners.

44. The underside craft inspection system of claim 37, further comprising:
one or more index positioner rails disposed on said index positioner and capable of supporting thereon said robot and when one or more rails are selected for inspection of said component and/or said sub-component, one or more of said index positioner rails align to one or more of selected rails; and
one or more index positioner drive subassembly proximate one or more of said index positioner rails and designed to mobilize a cart on said index positioner rails.

45. The underside craft inspection system of claim 44, wherein said index positioner drive subassembly includes a rack and pinion mechanism proximate at least one of said one or more rails and said cart, and said rack and pinion facilitates mobilization of said cart from said index positioner rails to said rails.

46. The underside craft inspection system of claim 31, wherein said one or more beds is any one of raised, recessed and even relative to a floor surface of an inspection facility unit.

47. The underside craft inspection system of claim 31, wherein said system includes two or more beds separated by a distance, and said system further comprising a plurality of bed connectors extending between said two or more beds to allow movement of a cart from a location on one bed to another location on another bed.

48. The underside craft inspection system of claim 37, further comprising a cart disposed on said index positioner, said cart designed to be mobile on said rails, and said cart capable of supporting thereon one or more of said robots.

49. The underside craft inspection system of claim 48, further comprising a rail drive sub-system proximate one or more of the rails, said rail drive subsystem facilitates mobilizing said cart on said rails and includes one member chosen from a group comprising a rack and pinion drive system, a motor-driven cable and chain system.

50. The underside craft inspection system of claim 49, further comprising one or more cart rails disposed on said cart and capable of supporting thereon said robot.

51. The underside craft inspection system of claim 50, further comprising a lower carriage secured on a cart and capable of movement in a direction that is perpendicular or parallel to a movement direction of said one or more rails.

52. The underside craft inspection system of claim 50, further comprising one or more cart drive subsystems proximate said one or more cart rails and designed to mobilize said lower carriage on said cart rails.

53. The underside craft inspection system of claim 52, wherein said at least one of said one or more cart drive subsystems include at least one member selected from a group consisting of a rack and pinion drive system, a motor-driven cable and chain system.

54. The system of claim 53, wherein said robot system includes a pedestal robot or a platform robot mounted on said lower carriage for inspecting locations on said craft that cannot be reached from said lower carriage in the absence of said pedestal robot or said platform robot.

55. A craft inspection facility unit comprising:
one or more beds;
an index positioner capable of supporting thereon one or more underside robots, each of which is associated with said NDI system and is capable of inspecting an underside of a craft; and
wherein said one or more beds facilitate mobilization of said index positioner to facilitate underside inspection of said craft using said one or more underside robots.

56. The craft inspection facility unit of claim 55, further comprising one or more rails disposed perpendicular to said one or more beds such that one or more beds are designed to align said index positioner to one or more predetermined rails.

57. The craft inspection facility unit of claim 55, further comprising one or more overhead robots associated with a non-destructive inspection (“NDI”) system and capable of inspecting at least an overhead portion of a craft, and wherein underside inspection of said craft using one or more underside robots is carried out in a corresponding manner to overhead inspection of said craft using said one or more overhead robots.

58. The craft inspection facility unit of claim 55, further comprising a cart secured on said index positioner, said cart capable of holding one or more robots, each of which is associated with a single NDI system.

59. The craft inspection facility unit of claim 58, wherein said cart is capable of being displaced by a drive sub-system that includes at least one member chosen from a group comprising of a rack and pinion drive system, a motor-driven cable system and a chain system.

60. The craft inspection facility unit of claim 59, further comprising a lower carriage secured on a cart and capable of movement in a direction that is perpendicular or parallel to said one or more beds.

61. The non-destructive inspection facility unit of claim 60, further comprising a pedestal robot or a platform robot mounted on said lower carriage for inspecting locations on said craft that cannot be reached by said lower carriage in the absence of said pedestal robot or said platform robot.

62. An inspection control system comprising:
one or more overhead robots designed to inspect an upper portion of a craft;
one or more overhead control subsystems, at least some of which are designed to control one of said one or more overhead robots;
one or more underside robots designed to inspect an underside portion of said craft;
one or more underside control subsystems, at least some of which are designed to control one of said one or more underside robots;
one or more computers capable of being communicatively coupled to said one or more overhead control subsystems and said one or more underside control subsystems; and
wherein during operation of said inspection control system, information from one control subsystem is conveyed to another control subsystem using said one or more computer systems.

63. The inspection control system of claim 62, further comprising:
an overhead robot workstation;
an underside robot workstation; and
wherein said overhead robot workstation and said underside robot workstation are designed to interact with said one or more computer systems, such that during operation of said inspection control system, information from one control subsystem is conveyed to another control subsystem through said overhead robot workstation and said underside robot workstation.

64. The inspection control system of claim 62, wherein said one or more overhead control subsystems further include:
a controller for transferring location information of said one of said one or more overhead robots during inspection; and
an integrating controller for integrating location information of two of said one or more overhead robots or for integrating scan paths, manual control points of said one of said one or more overhead robots and new points taught to said one of said one or more overhead robots during development of a reference database.

65. The inspection control system of claim 62, further comprises:
a collision detection avoidance subsystem for said one of said one or more overhead robots for avoiding collision between said one of said one or more overhead robots and said another of said one or more overhead robots or with a component and/or a sub-component of said craft; and
a collision detection avoidance subsystem for said one of said one or more underside robots for avoiding collision between said one of said one or more underside robots and said another of said one or more underside robots or with a component and/or a sub-component of a craft undergoing inspection.

66. The inspection control system of claim 62, wherein said one or more overhead control subsystems provides to said one or more computer systems any one information chosen from a group comprising a point of origin of said component and/or said sub-component, one or more boundary coordinates of said component and/or said sub-component, an overhead scan path, signal to commence underside inspection, component offset and sub-component offset.

67. A craft inspection system comprising:
one or more overhead robots designed to inspect an upper portion of a craft;
one or more underside robots designed to inspect an underside portion of said craft;
one or more computer systems capable of being communicatively coupled to said one or more overhead robots and to said one or more underside robots; and
wherein during operation of said inspection control system, said one or computer systems facilitate overhead robot and underside robot to inspect said craft in a corresponding manner.

68. The craft inspection system of claim 67, wherein said one or more computer systems use Boolean logic rules to facilitate overhead robot and underside robot to inspect said craft in a corresponding manner.
